(19) United States
(12) Patent Application Publication
(10) Pub. No.: US 2011/0207045 A1
(43) Pub. Date: Aug. 25, 2011

(54) TONER FOR ELECTROSTATIC LATENT IMAGE DEVELOPMENT AND PRODUCTION METHOD THEREOF

(75) Inventors: Anju HORI, Tokyo (JP); Shigenori KOUNO, Tokyo (JP); Asao MATSUSHIMA, Tokyo (JP); Noboru UEDA, Tokyo (JP); Kentarou MOGI, Tokyo (JP)

(73) Assignee: KONICA MINOLTA BUSINESS TECHNOLOGIES, INC., Tokyo (JP)

(21) Appl. No.: 13/024,759

(22) Filed: Feb. 10, 2011

(30) Foreign Application Priority Data
Feb. 22, 2010 (JP) 2010-035723

(51) Int. Cl. G03G 9/087; G03G 9/08

(52) U.S. Cl. 430/109.3; 430/137.14

(57) ABSTRACT

A toner for electrostatic latent image development is disclosed, comprising a binder resin which comprises a resin A comprising a copolymer comprised of at least a styrenic monomer unit and a (meth)acrylic monomer unit and a resin B comprising a copolymer comprised of at least a methacrylate monomer unit and a radical-polymerizable monomer unit containing plural carboxyl groups, and a total amount of the methacrylate monomer unit and the radical-polymerizable monomer unit containing plural carboxyl groups accounts for not less than 70% by mass and not more than 95% by mass of all monomer units forming the copolymer of the resin B.

This application claims priority from Japanese Patent Application No. 2010-035723, filed on Feb. 22, 2010, which is incorporated hereinto by reference.

### FIELD OF THE INVENTION

The present invention relates to a toner for electrostatic latent image development for use in electrophotographic image forming apparatuses (hereinafter, also denoted simply as a toner) and a production method of the toner for an electrostatic latent image development.

### BACKGROUND OF THE INVENTION

Recently, in the field of electrophotographic image forming apparatuses, a digital image processing technology and a technique for reducing toner particle sizes have rendered it feasible to form images of enhanced resolution, making it possible to provide prints of toner images in the field of printing in which prints were usually made employing plate making. Consequently, promptly making prints of high image quality became feasible without performing plate-making which had been an indispensable step in printing, and which was developed specifically in the field of shortrun printing in which small lots of printing at a level of several hundred to several thousand sheets were mainly ordered. Prints prepared in the field of shortrun printing include prints having enhanced glossiness such as photographic images; accordingly, to form toner images of enhanced glossiness, there was studied a toner using a resin with a low glass transition temperature and a low molecular weight so that the melted toner image surface became smooth upon fixing.

Further, taking into account the global environment, there was recently studied reduction of electric power consumption of an image forming apparatus. Specifically, there were studied techniques for reduction of electric power consumption in a fixing device. Techniques for achieving energy saving in a fixing device include a so-called low temperature fixing technique for melting a toner at a heating temperature lower than the conventional ones to perform print making with shortening the warm-up time from the standby state through low temperature fixing, and thereby achieving energy saving of the fixing device. From such a point of view, there was also studied a toner corresponding to low temperature fixing in which the glass transition temperature (Tg) of a resin forming the toner was set to be relatively low.

However, there were problems such that a toner in which the glass transition temperature or molecular weight of a resin was set to be relatively low, was easily deteriorated in heat stability, resulting in a blocking phenomenon of allowing toner particles to adhere or aggregate. In response thereto, there was proposed a toner having a so-called core/shell structure to correspond to low temperature fixing in which the resin particle surface of a relatively low glass transition temperature was covered with a resin of a relatively high glass transition temperature (as described in, for example, JP 2002-116574A).

However, a toner meltable at a relatively low temperature was low in viscosity and exhibited a tendency of internal cohesion of a toner layer being lowered, leading to a tendency of being easily ruptured when subjected to stress. Specifically, there were produced problems such as hot off-set that, when passing through a fixing device, the melted toner layer was pealed off by a fixing roller and easily ruptured, and the thus ruptured toner pieces adhered to the roller surface, leading to staining due to transferred materials. Further, as a transferred material passes, a roller or belt used in a fixing device loses its heat, so that in cases when there is a portion of the rotation cycle of a roller or the like being varied on the same paper surface, the paper temperature varies, causing uneven gloss. In light of such a background, there was proposed an image forming method achieving both low temperature fixability and glossiness control of a toner image by the combination of a toner using resins mainly composed of a crystalline resin and a fixing device installed with a heating roller and an endless belt (as described in, for example, JP 2003-029463A).

Further, considering development to the field of shortrun printing, the toner described in the foregoing JP 2003-029463A is also required to perform stable achievements of low temperature fixing and control of image glossiness under conditions of conducting continuous printing. In addition thereto, when performing continuous printing, there must be avoided occurrence of glossiness difference between prints and it is desired to achieve stable continuous printing without causing print-to-print variations in glossiness.

However, there was neither description nor suggestion in the foregoing JP 2003-029463A with respect to continuous printing at a level of several hundred to several thousand sheets which was conducted in the field of shortrun printing and it was unspecified whether or not continuous printing is feasible, while achieving compatibility of low temperature fixability and glossiness control of a toner image. Further, it was not specified whether stable continuous printing was performed without causing print-to-print variations in glossiness. Thus, it was difficult to judge from the description of the foregoing JP 2003-029463A whether techniques disclosed in JP 2003-029463A are developable to continuous printing conducted in the field of shortrun printing.

### SUMMARY OF THE INVENTION

The present invention is related to a toner capable of melting and fixing a toner image at a lower temperature than conventional fixing temperatures, being a so-called low-temperature-fixable toner. It is therefore an object of the invention to provide a toner capable of forming toner images within the same paper sheet without causing uneven gloss, even when performing continuous printing. Further, it is an object of the invention to provide a toner capable of performing stable continuous printing at a low fixing temperature without causing print-to-print variations in glossiness.

Further, it is an object of the invention to provide a low-temperature-fixable toner having an appropriate strength without being ruptured when subjecting a melted toner to stress. Namely, it is an object of the invention to provide a low-temperature-fixable toner not causing image staining, so-called hot-offset, due to toner attaching to fixing rollers or transfer paper, resulting from rupture of a toner layer.

The foregoing problems related to the present invention can be overcome by the constitutions described below.

Thus, one aspect of the present invention is directed to a toner for electrostatic latent image development comprising a binder resin and a colorant, wherein the binder resin comprises a resin. A and a resin B, and the resin A comprises a copolymer comprised of at least a styrenic monomer unit and a (meth)acrylic monomer unit and the resin B comprises a copolymer comprised of at least a methacrylate monomer unit and a radical-polymerizable monomer unit containing plural carboxyl groups (—COOH), and the proportion of the total amount of the methacrylate monomer unit and the radical-polymerizable monomer unit containing plural carboxyl groups (—COOH) is not less than 70% by mass and not more than 95% by mass of all polymerizable monomer units which form the copolymer of the resin B.

Another aspect of the present invention is directed to a method of producing a toner for electrostatic latent image development comprising a binder resin and a colorant, the method comprising:

allowing a particulate resin comprising a resin A and a resin B to aggregate, wherein the resin A comprises a copolymer comprised of at least a styrenic monomer unit and a (meth)acrylic monomer unit and the resin B comprises a copolymer comprised of at least a methacrylate monomer unit and a radical-polymerizable monomer unit containing plural carboxyl groups (—COOH), and the proportion of the total amount of the methacrylate monomer unit and the radical-polymerizable monomer unit containing plural carboxyl groups (—COOH) is not less than 70% by mass and not more than 95% by mass of all polymerizable monomer units which form the copolymer of the resin B.

Further, another aspect of the present invention is direct to a method of producing a toner for electrostatic latent image development comprising a binder resin and a colorant, the method comprising:

allowing a particulate resin comprising a resin A and a particulate resin comprising a resin B to aggregate,

wherein the resin A comprises a copolymer comprised of at least a styrenic monomer unit and a (meth)acrylic monomer unit and the resin B comprises a copolymer comprised of at least a methacrylate monomer unit and a radical polymerizable monomer unit containing plural carboxyl groups (—COOH), and the proportion of the total amount of the methacrylate monomer unit and the radical-polymerizable monomer unit containing plural carboxyl groups (—COOH) is not less than 70% by mass and not more than 95% by mass of all polymerizable monomer units which form the copolymer of the resin B.

The toner related to the invention made it possible to perform low temperature fixing in which a toner image was melted and fixed at a heating temperature lower than a conventional fixing temperature, rendering it feasible to perform stable image formation without causing uneven gloss within a sheet, even when conducting continuous printing at a level over several hundred to several thousand sheets. Further, no print-to-print variation in glossiness resulted and continuous formation of finely finished glossy images became feasible. Furthermore, toner images formed by the toner of the invention did not cause rupture of the toner layer even when subjected to stress under the melted state, rendering it possible to overcome problems of image staining due to hot-offset caused by rupture of the toner layer.

Thus, a tough toner layer exhibiting a high tolerance for stress was formed according to the invention, rendering it feasible to stably form images of superior image quality without causing uneven gloss within a sheet or between sheets, even when performing continuous printing over several hundred to several thousand sheets. Thereby, it became feasible to provide a toner suitable in the field of shortrun printing which has opportunities of conducting continuous printing over several hundred to several thousand sheets.

### BRIEF DESCRIPTION OF THE DRAWING

FIG. 1 shows a sectional view of an image forming apparatus capable of forming images by use of the toner related to the present invention.

### DETAILED DESCRIPTION OF THE INVENTION

The present invention relates to a toner used for development of electrostatic images which comprises at least a binder resin and a colorant and in particular to a toner used for development of electrostatic images which is capable of forming images of enhanced gloss and performing low temperature fixing when performing continuous printing over several hundred to several thousand sheets, as is often conducted in the field of short-run printing.

With respect to causes of producing uneven gloss within a paper sheet or difference in gloss among printed sheets, it was supposed that a slight temperature change occurred during fixing, whereby a slight change in fluidity of a melted toner was generated, affecting glossiness. Namely, it was presumed that the fluidity of a melted toner exhibited temperature dependency and a slight change in fluidity of the toner affected the toner image quality in the form of uneven gloss within a sheet or difference in gloss among printed sheets.

Further, noting a toner capable of being fixed at a low temperature, it was presumed that when heating a melted toner, fluidity or viscosity of the melted toner was varied due to the action of heating. Namely, it was presumed that image formation at a low fixing temperature easily resulted in a temperature environment higher than the melting temperature of the toner, so that it was thought to provide, within a toner particle, a means to absorb extra heat energy causing fluidity or viscosity of a melted toner to change.

It was presumed that a structure in which a resin phase fusible at a relatively high temperature was finely dispersed in a resin phase fusible at a relatively low temperature, attained fusion at a low temperature and even when an extra heat remained after the fusion, the dispersed resin phase absorbed the heat, resulting in no change in fluidity or viscosity.

Accordingly, supposing formation of a binder resin for a toner with a incompatible resin, it was found that the binder resin was formed of two kinds of resins, as described below. Namely, the binder resin was formed by allowing a resin A comprising a copolymer formed of at least a styrenic monomer and a (meth)acrylic monomer and a resin B comprising a copolymer formed of at least a methacrylate monomer and a radical-polymerizable monomer containing plural carboxyl groups (—COOH) to be contained.

To acquire a sea-island structure in which a thermally stable resin B phase is finely dispersed in the resin A phase to attain low temperature fixing, there was noted addition amounts of a methacrylate monomer and a radical polymerizable monomer containing plural carboxyl groups to form a copolymer contained in the resin B. Consequently, it was found that when the addition amount of these polymerizable monomers was controlled so as to be not less than 70% and not more than 95% of all of the polymerizable monomers to form the copolymer, an excellent sea-island structure was acquired.

Namely, it was presumed that formation of the sea-island structure was so controlled that the resin B phase did not affect melting of the resin A in the temperature region of the resin A being melted to attain incompatibility of the resin B phase with the resin A phase under a low temperature environment. Meanwhile, it was also presumed that, when reached a high temperature state of the resin B being melted, the resin B is melted and fluidity of a toner was so controlled that the melted resin B did not thermally affect fluidity of the resin A. It was further presumed that the resin B was finely dispersed in the resin A phase to form a sea-island structure, whereby the resin phase B functioned as a filler in the resin phase A to provide appropriate strength to the melted toner. Thus, it was presumed that, as a result of giving a filler function thereto, the toner layer was not ruptured even when a mechanical load was applied to the melted toner and occurrence of offsetting was avoided by strengthening the toner layer. Further, it was found that formation of the resin B was so controlled that the addition amount of the foregoing polymerizable monomers accounted for not less than 70% and not more than 95% by mass of all of polymerizable monomers and thereby, the sea-island structure achieving the performance described above is formed.

In the invention, it was presumed that the resin B was thus allowed to exist incompatibly in the resin A phase and even when extra heat is easily applied to a melted toner in a high temperature state, the resin B absorbs such extra heat, whereby fluidity at the time of low-temperature fixing was maintained and change in gloss was prevented. Further, it was presumed that the resin B functioned as filler and when stress was applied to the melted toner, the melted toner layer was not ruptured and occurrence of offsetting is avoided. Consequently, even when the temperature on a transfer material subtly changed at the time when performing continuous printing or passing through a fixing device, uneven gloss was inhibited and excellent image formation was realized without causing uneven gloss on a single sheet or between plural sheets.

Hereinafter, the embodiments of the present invention will be described in detail.

The toner related to the invention comprises at least a resin A and a resin B, as a binder resin. The expression “comprises at least a resin A and a resin B” represents two cases of (i) containing a resin A, a resin B and at least a resin other than the resins A and B, and (ii) containing only the resin. A and the resin B. As described later, it is preferred that the toner related to the invention contains a resin A, a resin B and at least a resin other than the resins A and B.

There will be further described a resin A and a resin B.

In the invention, the resin A comprises a copolymer comprising at least a styrenic monomer unit and a (meth)acrylic monomer unit. Namely, resin A is a resin which comprises a copolymer fanned by use of at least a styrenic monomer and a (meth)acrylic monomer. Herein, the styrenic monomer refers to a polymerizable vinyl monomer containing a benzene ring as a functional group in its molecular structure, and includes styrene and styrene derivatives in which a benzene ring is bonded to various functional groups such as a hydrocarbon groups, for example, methyl or phenyl, or a halogen group.

The (meth)acrylic monomer refers to a polymerizable vinyl monomer containing at least one of a carboxyl group (denoted as —COOH) and a carboxylic acid ester structure (denoted as —COOR) in the molecular structure. The expression “(meth)acrylic” represents its structure in which the vinyl group site in the monomer structure is either a methacryl group [also denoted as CH₂═C(CH₃)COO—] or an acryl group (also denoted as CH₂═CHCOO—). Specific examples of the styrenic monomer and the (meth)acrylic monomer are described later.

In the invention, “resin B” is a resin which comprises a copolymer formed by use of at least a methacrylate monomer (also called methacrylic acid ester monomer) and a radical-polymerizable monomer containing plural carboxyl groups (also denoted as —COOH). Herein, the methacrylic acid ester monomer refers to polymerizable vinyl monomer containing a methacrylate structure [also denoted as CH₂═C(CH₃)COOR]. Further, the radical-polymerizable monomer containing plural carboxyl groups refers to a polymerizable monomer containing at least two carboxyl groups in the molecular structure and an unsaturated, radical-polymerizable bond as typified by a vinyl group.

In the invention, the total amount of the foregoing methacrylate monomer unit and the radical-polymerizable monomer unit containing plural carboxyl groups (—COOH) accounts for not less than 70% by mass and not more than 95% by mass of the total polymerizable monomer units forming the copolymer of resin B. Namely, the foregoing contained in the resin B is formed by using a commonly known radical-polymerizable monomer (as typified by a vinyl monomer) in addition to a methacrylate monomer and a radical-polymerizable monomer containing plural carboxyl groups.

A binder resin constituting the toner related to the invention comprises a resin A and a resin B, as described earlier. Such a binder resin comprising a resin A and a resin B can be prepared in accordance with commonly known methods. Specific examples thereof include a method (i) which comprises the steps of allowing microparticles composed of a resin B within particles composed of a resin A, and aggregating the resulting resin particles to form a binder resin; and a method (ii) which comprises the steps of preparing a dispersion of resin A particles and a dispersion of resin B particles, mixing both dispersions, and allowing resin particles to aggregate to form a binder resin. Of the foregoing methods, the method (i) is advantageous in preparing resin particles in which the resin B is uniformly dispersed, as compared to the method (ii).

A binder resin forming a toner related to the invention usually contains the resin A in larger amount than the resin B. Specifically, the resin B is contained preferably in an amount of not less than 2% by mass and not more than 20% by mass of the sum of resin A and resin B. It was presumed that such a binder resin containing the resin A in a larger amount than the resin B might realize a resin of a structure in which a resin phase meltable at a relatively high temperature is dispersed in a resin phase meltable at a relatively low temperature. Accordingly, it was presumed that the resin A of a larger content attained melting of its toner at a relatively low temperature and even when extra heat remained after toner particles melted, the resin B finely dispersed in the resin phase absorbed such extra heat without varying fluidity or viscosity of the toner.

Further, it was presumed that the resin B which was dispersed in a smaller amount in a resin phase, would function as a filler, rendering it feasible to provide appropriate strength to a melted toner. Consequently, it was presumed that, even when a mechanical load was applied to the melted toner, the resulting toner layer would not be raptured and such action might contribute to prevention of offset.

Hereinafter, there will be described polymerizable monomers used for formation of the resin A and the resin B contained in a binder resin constituting the toner related to the invention.

As described earlier, the resin A used in the invention comprises a copolymer comprised of at least a styrenic monomer unit and a (meth)acrylic monomer unit. Namely, the resin A comprises a copolymer formed of at least a styrenic monomer and a (meth)acrylic monomer, in which the styrenic monomer and the (meth)acrylic monomer are indispensable polymerizable monomer components. Specific examples of such a styrenic monomer include styrene and styrene derivatives as shown in (1) below.

The foregoing (meth)acrylic monomer include a methacrylic monomer and an acrylic monomer. Specific examples of such a methacrylic monomer include methacrylic acid [also denoted as CH₂═C(CH₃)COOH] and methacrylate (or methacrylic acid ester) derivatives, as shown in (2) below. Specific examples of such an acrylic monomer include acrylic acid [also denoted as CH₂═CHCOOH] and acrylic acid ester derivatives, as shown in (3) below.

(1) Styrene and styrene derivative:

styrene, o-methylstyrene, m-methylstyrene, p-methylstyrene, α-methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, p-n-dodecylstyrene;

(2) Methacryl acid ester derivative:

methyl methacrylate, ethyl methacrylate, n-butyl methacrylate, isopropyl methacrylate, isobutyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate, dimethylaminoethyl methacrylate;

(3) Acrylic acid ester derivative:

methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate, phenyl acrylate.

As described above, the resin A comprises a copolymer comprised of at least a styrenic monomer unit and a (meth)acrylic monomer unit. Specifically, when the resin A comprises a copolymer comprised of a styrenic monomer unit and a methacrylic monomer unit, it is preferred that the styrenic monomer unit and the methacrylic monomer unit account for 80 to 98% and 2 to 20% by mass of the resin A, respectively. When the resin A comprises a copolymer comprised of a styrenic monomer unit, a methacrylic monomer unit and an acrylic monomer unit, it is preferred that the styrenic monomer unit, the methacrylic monomer unit and the acrylic monomer unit account for 45 to 80%, 2 to 10% and 20 to 45% by mass of the resin A, respectively.

Of the foregoing polymerizable monomers, a styrenic monomer, a methacrylic monomer and an acrylic acid ester monomer are preferably styrene, methacrylic acid and n-butyl acrylate, respectively, and a copolymer formed by use of these monomers is specifically preferred.

Further, the resin B used in the invention contains a copolymer formed of at least a methacrylate monomer and a radical-polymerizable monomer containing plural carboxyl groups (—COOH). Namely, in the copolymer contained in the resin B, such a methacrylate monomer and a radical-polymerizable monomer containing plural carboxyl groups are indispensable polymerizable monomer components.

The foregoing (meth)acrylic acid ester monomer includes a methacrylate monomer and acrylic acid ester monomer. Specific examples of a methacrylate monomer include methacrylate derivatives, as shown in the foregoing (2). Specific examples of acrylic acid ester include acrylic acid ester derivatives, as shown in the foregoing (3). Further, specific examples of a radical polymerizable monomer containing plural carboxyl group (—COOH) include compounds, as shown in the following (4).

(4) Radical-polymerizable monomer containing plural carboxyl group (—COOH):

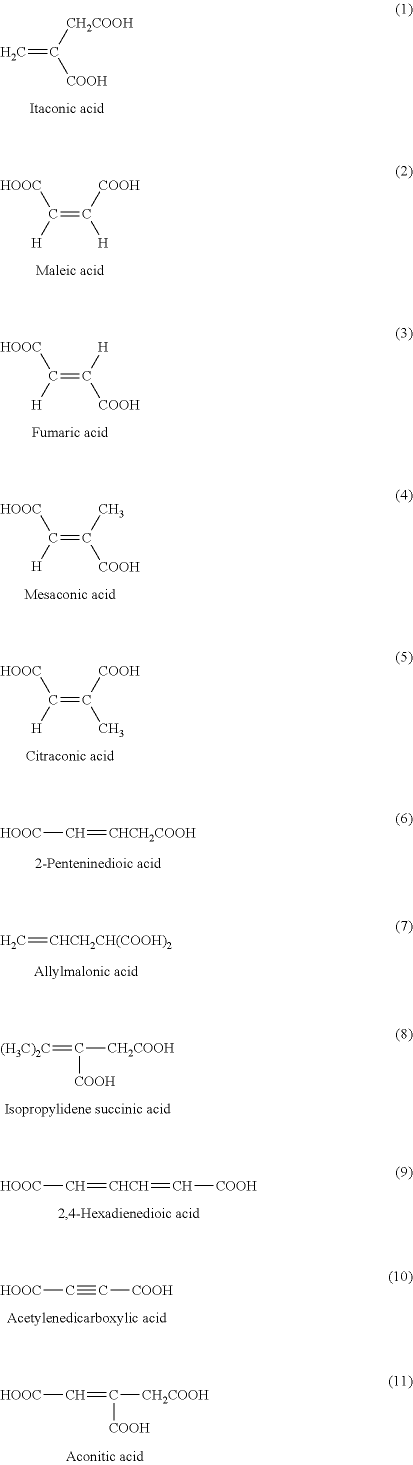

Of the foregoing radical-polymerizable monomers containing plural carboxyl groups, itaconic acid, maleic acid and fumaric acid are preferred, and itaconic acid is more preferred. A (meth)acrylic acid ester derivative is preferably methyl methacrylate or ethyl methacrylate. Further, the resin B is specifically preferably a copolymer formed of methyl methacrylate and itaconic acid, a copolymer formed of ethyl methacrylate and maleic acid, or a copolymer formed of ethyl methacrylate and itaconic acid.

Hereinafter, there will be described glass transition temperature (Tg), weight average molecular weight (Mw) and softening point (Tsp) of the resin A and the resin B contained in a binder resin constituting the toner related to the invention. In the invention, it is preferred to set the weight average molecular weight, glass transition temperature and softening point of the resin A lower than those of the resin B. It is supposed that setting the foregoing physical properties at a relatively low level contributes to melting of a toner at a heating temperature lower than conventional heating temperatures and to enhanced image gloss. It is also supposed that when a resin B having set the foregoing physical properties to higher levels is allowed to exist within the resin A, unevenness or variation in gloss of toner images is effectively inhibited.

Namely, it is supposed that advantageous effects achieved by the presence of a resin B, such as prevention of rupture of a toner layer by providing strength to the toner or glossiness stabilization by heat absorption are attained by allowing a resin B exhibiting relatively high physical properties to exist within a resin A. Thus, control of the resin A and the resin B is expected to render it feasible to perform print making without causing unevenness or variation in gloss of toner images when conducting continuous printing of hundreds to thousands of sheets which increases chances of stress being frequently and continuously applied or results in extra heat energy.

A resin A contained in the binder resin constituting the toner related to the invention preferably exhibits a glass transition temperature of not less than 30° C. and not more than 50° C., and more preferably not less than 35° C. and not more than 45° C. A glass transition temperature of a resin A falling within the foregoing range is speculated to contribute to superior low temperature fixability and an enhancement of heat stability. Namely, it is presumed that a glass transition temperature of a resin A being 30° C. or higher renders it feasible to maintain the frozen state of the resin A under a working environment of an apparatus such as in an office or a usual using environment such as a storage environment of a toner, whereby initiation of micro-Brownian movement of molecules is retarded, and results in enhanced heat stability under an image forming environment or a storage environment of a toner. Further, it is presumed that when the glass transition temperature is 50° C. or lower, the frozen state of the resin A is released at an appropriate temperature, whereby initiation of micro-Brownian movement of molecules becomes easier, and promotes melting of the toner at a relatively low temperature.

The resin A preferably exhibits a weight average molecular weight (Mw) of not less than 10,000 and not more than 30,000, more preferably not less than 12,000 and not more than 28,000, and still more preferably not less than 14,000 and not more than 26,000. The weight average molecular weight of the resin A falling with the foregoing range is speculated to result in glossiness balanced with low temperature fixability. Namely, it is presumed that a weight average molecular weight of the resin A being not less than 10,000 results in enhanced viscosity and internal cohesion, preventing rupture of the melted toner layer at the time of fixing, whereby occurrence of hot offset, which causes staining of images or in an apparatus, is securely inhibited. It is also presumed that melting and fixing of a toner at a lower temperature relative to a conventional fixing temperature concurrently becomes feasible. Further, it is presumed that a certain extent of difference from the molecular weight of the resin B makes it possible to maintain incompatibility with the resin B, which makes sure that the resin B acts as a filler to impart strength.

The resin A preferably exhibits a softening point (also denoted as Tsp) of not less than 80° C. and not more than 100° C. and more preferably not less than 84° C. and not more than 96° C. The softening point of a resin A falling within the foregoing range is speculated to contribute to impart low temperature fixability and thermal storage stability to a toner. Namely, it is presumed that softening point of the resin A being not less than 80° C. results in a toner difficult to melt, whereby the temperature range for storage of the toner is broadened, contributing to enhancement of thermal storage stability. It is also presumed that softening point of the resin. A being not more than 100° C. make sure that a toner melts and is fixed.

A resin B contained in the binder resin constituting the toner related to the invention preferably exhibits a glass transition temperature (Tg) of not less than 60° C. and not more than 85° C., and more preferably not less than 65° C. and not more than 80° C. In the invention, the glass transition temperature of a resin B falling within the foregoing range is speculated to contribute to impart an adequate strength to the toner and to absorb extra heat. Thus, it is presumed that when the glass transition temperature of the resin B is not less than 60° C., the initiation temperature of micro-Brownian movement is set relatively high, so that the resin B acts as filler even at a relatively high temperature and continue to impart sufficient strength to the toner layer. Consequently, action as a filler of the resin B securely comes into effect to a toner layer melted at the time of fixing, and since sufficient strength is imparted, occurrence of rupture is surely prevented. Further, it is presumed that adhesion of a toner to the surface of a fixing roller is securely prevented, which dissolves stains on the surface of transfer paper, caused by an adhered toner, so-called hot-offset.

It is assumed that the initiation temperature of micro-Brownian movement is set relatively high, so that extra heat generated in the fixing stage is securely absorbed and assures that it maintains the viscosity of the melted toner at a given level.

It is presumed that a glass transition temperature of not more than 85° C. enables initiation of micro-Brownian movement at a lower temperature than conventional temperatures, so that the resin B contributes to an enhancement of adhesion of a toner image onto a transfer paper.

The resin B preferably exhibits a weight average molecular weight (Mw) of not less than 100,000 and not more than 400,000, and more preferably not less than 150,000 and not more than 350,000. The weight average molecular weight of the resin B falling within the foregoing range is speculated to achieve functions as a filler in a binder resin to contribute to providing an adequate strength to a toner and also to participate in foil, ration of excellent images. Namely, it is presumed that when a weight average molecular weight of the resin B is not less than 100,000, a function as a filler in a binder resin comes into effect through such a high molecular weight; consequently, sufficient strength is provided to a melted toner layer at the time of fixing to surely inhibit occurrence of rupture, which contributes to enhancement of hot offset resistance. It is presumed that, when the weight average molecular weight of the resin B is not more than 400,000, the resin A melts within a prescribed time in the fixing step while absorbing extra heat for the resin A, which contributes to formation of glossy images.

The resin B preferably exhibits a softening point of not less than 170° C. and not more than 190° C., more preferably not less than 172° C. and not more than 188° C. and still more preferably not less than 174° C. and not more than 186° C. The softening point of the resin B falling within the foregoing range is speculated to contribute to formation of a glossy image plane without unevenness or variation in gloss. Namely, it is presumed that the resin B which exhibits a softening point of not less than 170° C. securely melts in fixing, while absorbing extra heat for the resin A; consequently, fixing is performed without varying the viscosity of a melted toner. It is presumed that the resin B which exhibits a softening point of not more than 190° C. achieves melting of a toner and also exhibits the role as a filler under a certain extent of high temperature; consequently, providing sufficient strength to the melted toner layer can be continued, which may contribute to assured prevention of rupture of the toner layer.

The foregoing weight average molecular weight (Mw), glass transition temperature (Tg) and softening point (Tsp) of the resin A or the resin B can be measured or calculated in the manner, as described below.

The glass transition temperature of the resin A or the resin B can be determined by using commonly known methods for determining a glass transition temperature. Hereinafter, there will be described the procedure to measure a glass transition temperature by using a differential scanning calorimeter, as one of several typical methods for determining a glass transition temperature.

The glass transition temperature can be measured by using DSC-7 differential scanning colorimeter and TAC7/DX thermal analyzer controller (both produced by Perkin Elmer Corp.).

The measurement is conducted as follows. A toner of 5.0 mg is precisely weighed to two places of decimals, sealed into an aluminum pan (KIT NO. 0219-0041) and set into a DSC-7 sample holder. An empty aluminum pan is used as a reference.

The temperature was controlled through heating-cooling-heating at a temperature-rising rate of 10° C./min and a temperature-lowering rate of 10° C./min in the range of 0 to 200° C. An extension line from the base-line prior to the initial rise of the first endothermic peak and a tangent line exhibiting the maximum slope between the initial rise and the peak are drawn and the intersection of both lines is defined as the glass transition point.

Methods for determining a glass transition temperature include a method for calculating a theoretical glass transition temperature, as described below. Herein, the theoretical glass transition temperature is calculated by multiplying the glass transition temperature of the individual components constituting a copolymer resin in the case when they each form a homopolymer by the respective component mass fractions.

Namely, the theoretical glass transition temperature Tg (which is represented by a Kelvin temperature, Tg′) is calculated from the following equation (1) by using glass transition temperatures of homopolymers corresponding to components constituting a copolymer resin:

1/Tg′=W1/T1+W2/T2+ . . . +Wn/Tn

Wherein W1, W2, . . . Wn each represent a mass fraction of an individual polymerizable monomer to all polymerizable monomers constituting a copolymeric resin; T1, T2, . . . Tn each represent a glass transition temperature (in Kelvin temperature) of a homopolymer formed by using the individual polerizable monomer.

In the measurement of the weight average molecular weight by the GPC method, first a measurement sample is dissolved in tetrahydrofuran so that its concentration is 1 mg/ml. Dissolution is carried out for 5 minutes by using an ultrasonic dispersing machine under room temperature to obtain a sample solution. Then, after treating the sample solution through a membrane filter of a 0.2 μm pore size, 10 μL of the sample solution was poured into a measurement apparatus (GPC apparatus). Specific examples of conditions to measure a weight average molecular weight by the GPC method are shown below:

Apparatus: HLC-8220 (produced by TOSO Co., Ltd.)

Column: TSK guard column+TSK gel Super HZM-M₃

Flow rate: 0.2 ml/min

Detector: Refractive index detector (RI detector)

In the molecular weight measurement of a sample, a molecular weight distribution of the sample was calculated by using a calibration curve which was measured by using monodisperse polystyrene standard particles. It is preferred that ten kinds of polystyrenes are used for calibration curve measurement.

A softening point can be determined by commonly known methods, such as a flow tester method. A softening point measurement by a flow tester method is conducted in the following manner.

(1) Preparation of sample:

Under an environment of 24±1° C. and 50±5% RH, 1.1 g of a toner is placed into a petri dish, flattened out, allowed to stand for 12 hrs and compressed under a pressure of 3.75×10⁸ Pa for 30 sec. by using a molding machine (SSP-A, produced by Shimazu Seisakusho Co., Ltd.) to form a disc-molded sample of 1 cm diameter.

(2) Measurement of softening point:

The foregoing sample was set into a flow tester (CFT-500D, produced by Shimazu Seisakusho Co., Ltd.) under an environment of 24±5° C. and 50±20% RH. The sample is extruded through a hole of a cylinder type die (1 mm×1 mm) by using a piston of 1 cm diameter under conditions of a load of 180N, a starting temperature of 60° C., pre-heating time of 300 sec. and a temperature increasing rate of 6° C./min. Extrusion was carried out after completion of pre-heating. An off-set method temperature (T_{offet}) which is measured at an offset value of 5 mm in a melting-temperature measurement by a temperature increasing method, is defined as the softening point of the toner.

The toner related to the invention achieves low temperature fixing through a binder resin comprising at least a resin A and a resin B, as described earlier and therefore, a core shell structure in which a core portion comprises a binder resin containing at least the resin A and the resin B is practically preferred. Namely, covering the surface of a binder resin containing at least the resin A and the resin B with a resin exhibiting a relatively high glass transition temperature renders it feasible to avoid influencing thermal storage stability. Preferably, the resin A and the resin B of the core portion account for 85 to 95% by mass of the binder resin.

When a toner of the invention has a core shell structure, the mass ratio of a core portion preferably is not less than 70% by mass and not more than 95% by mass, and more preferably 85 to 95% by mass. The foregoing effects brought about by a binder resin containing at least a resin A and a resin B is stably achieved by allowing a mass ratio of a core portion to fall within the foregoing range, even when a resin constituting a shell is present.

It is preferred to form a resin constituting a shell by using a polymerizable monomer which is used for preparation of the foregoing copolymer contained in the resin A. It is feasible to form a shell by using a styrenic monomer and a (meth)acrylic monomer, as described earlier. Specifically, it is feasible to form a shell by using (1) styrene or a styrene derivative, (2) a methacrylic acid ester derivative and (3) an acrylic acid ester derivative, as described earlier. For example, one of the preferably shell resins is a copolymer formed by using styrene, n-butyl acrylate and methacrylic acid, as described in Examples set forth later.

The toner related to the invention preferably contains a shell resin formed by using monomers, as described above, in an amount of 5 to 15% by mass of all of resins. A shell resin content falling within the foregoing range realizes stable thermal storage stability and also causes low temperature fixability by a resin A and a resin B to stably come into effect.

The glass transition temperature (Tg) of a resin used for a shell (hereinafter, also denoted simply as a shell resin) is preferably not lower than 45° C. and not higher than 55° C., and more preferably not lower than 47° C. and not higher than 53° C. It is thought that, when a glass transition temperature of a shell resin falls within the foregoing range, it expands the temperature range for storage of a toner and also renders it feasible to perform fixing of toner images smoothly in continuous printing. Namely, when the glass transition temperature of a shell resin is not lower than 45° C., a temperature range in which the shell resin exists in a frozen state is inhibited to a certain extent and occurrence of coalescence of toner particles in a storage state is also avoided. Further, a glass transition temperature of not higher than 55° C. causes molecular chains constituting the shell resin used for a shell to initiate micro-Brownian movement, rendering it feasible to perform smooth melting of a toner image at the initial stage of fixing. Therefore, it is thought to contribute to fixing a toner image for a short time when conducting continuous printing.

The weight average molecular weight (Mw) of a shell resin preferably is not less than 5,000 and not more than 20,000, and more preferably not less than 9,000 and not more than 16,000. It is thought that, when the weight average molecular weight of a shell resin falls within the foregoing range, it acts to promote an enhancement of toner layer strength and formation of a glossy surface. Namely, when the weight average molecular weight of a shell resin is not less than 5,000, the shell resin achieves sufficient viscosity and internal cohesive force, leading to enhanced strength of a toner layer at the time of fixing. As a result, prevention of rupture of a melted toner layer by the resin B contained in a core is sufficiently achieved, rendering it possible to avoid occurrence of staining of an image or within an apparatus, due to hot-offset caused by rupture of the toner layer. When the weight average molecular weight of a shell resin is not more than 20,000, superior viscosity and internal cohesive force are maintained, which provide adequate strength to a melted toner layer at the time of fixing and also results in smooth-melting of a shell resin without adversely affecting gloss performance of the toner image surface.

The softening point of a shell resin preferably is not less than 100° C. and not more than 120° C., and more preferably not less than 104° C. and not more than 116° C. It is thought that the softening point of a shell resin falling within the foregoing range contributes to compatibility of thermal storage stability and low temperature fixability of a toner. Namely, the softening point of a shell resin being 100° C. or higher is thought to contribute to 3 enhancement of thermal storage stability and, for example, even when allowed to stand over long period of time, there is no concern of toner particles adhering to one another. Further, when the softening point of a shell resin is 120° C. or lower, it is thought that melting of a toner proceeds smoothly in the fixing stage, which contributes to stable performance of melting and fixing of a toner image within a prescribed time.

Hereinafter, there will be described materials for use in preparation of the toner related to the invention, that is, materials used for formation of a binder resin, such as a polymerizable monomer, a colorant and wax other than the foregoing materials.

In addition to the foregoing styrenic monomer, (meth)acrylic monomer and a radical-polymerizable monomer containing plural carboxyl groups (—COOH), the binder resin constituting the toner related to the invention may employ radical-polymerizable monomers (or monomer units), as shown below:

### (1) Olefins:

ethylene, propylene, isobutylene;

(2) Vinyl esters:

vinyl propionate, vinyl acetate, vinyl benzoate;

(3) Vinyl ethers:

vinyl methyl ether, vinyl ethyl ether;

(4) Vinyl ketones:

vinyl methyl ketone, vinyl ethyl ketone, vinyl hexyl ketone;

(5) N-vinyl compounds:

N-vinylcarbazole, N-vinylindole, N-vinylpyrrolidone;

(6) Vinyl compounds:

vinylnaphthalene, vinylpyridine;

(7) Acrylic acid or methacrylic acid derivatives:

acrylonitrile, methacrylonitrile and acrylamide.

There may be used a polymerizable monomer containing an ionically dissociative group other than a polymerizable monomer containing plural carboxyl groups. Examples of such an ionically dissociative group include a sulfonic acid group and a phosphoric acid group and a polymerizable monomer containing an ionically dissociative group is one which contains such a group.

Specific examples of a polymerizable monomer containing an ionically dissociative group include maleic acid monoalkyl ester, itaconic acid monoalkyl ester, styrene sulfonic acid, allylsulfosuccinic acid, 2-acrylamido-2-methylpropane sulfonic acid, acidophosphooxyethyl methacrylate and 3-chloro-2-acidophosphooxypropyl methacrylate.

There is also usable a resin of a crosslinking structure which can also be prepared by using poly-functional vinyl compounds. Examples of poly-functional vinyl compounds include divinylbenzene, ethylene glycol dimethacrylate, ethylene glycol diacrylate, diethylene glycol dimethacrylate, diethylene glycol diacrylate, triethylene glycol dimethacrylate, triethylene glycol diacrylate, neopentylene glycol dimethacrylate, and neopentylene glycol diacrylate.

Colorants usable in the toner relating to the present invention include those known in the art and specific examples thereof are as follows:

Examples of black colorants include carbon black such as Furnace Black, Channel Black, Acetylene Black, Thermal Black and Lamp Black and magnetic powder such as magnetite and ferrite.

Magenta and red colorants include C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48, C.I. Pigment Red 53:1, C.I. Pigment Red 57:1, C.I. Pigment Red 60, C.I. Pigment Red 63, C.I. Pigment Red 64, C.I. Pigment Red 68, C.I. Pigment Red 81, C.I. Pigment Red 83, C.I. Pigment Red 87, C.I. Pigment Red 88, C.I. Pigment Red 89, C.I. Pigment Red 90, C.I. Pigment Red 112, C.I. Pigment Red 114, C.I. Pigment Red 122, C.I. Pigment Red 123, C.I. Pigment Red 139, C.I. Pigment Red 144, C.I. Pigment Red 149, C.I. Pigment Red 150, C.I. Pigment Red 163, C.I. Pigment Red 166, C.I. Pigment Red 170 C.I. Pigment Red 177, C.I. Pigment Red 178, C.I. Pigment Red 184, C.I. Pigment Red 202, C.I. Pigment Red 206, C.I. Pigment Red 207, C.I. Pigment Red 209, C.I. Pigment Red 222 C.I. Pigment Red 238 and C.I. Pigment Red 169.

Orange or yellow colorants include C.I. Pigment Orange 31, C.I. Pigment Orange 43, C.I. Pigment Yellow 12, C.I. Pigment Yellow 14, C.I. Pigment Yellow 15, C.I. Pigment Yellow 17, Pigment Yellow 74, C.I. Pigment Yellow 83 C.I. Pigment Yellow 93, C.I. Pigment Yellow 94, C.I., Pigment Yellow 138, C.I. Pigment Yellow 155, C.I. Pigment Yellow 162, C.I. Pigment Yellow 180 and C.I. Pigment Yellow 185.

Green or cyan colorants include C.I. Pigment Blue 2, C.I. Pigment Blue 3, C.I. Pigment Blue 15, C.I. Pigment Blue 15:2, C.I. Pigment Blue 15:3, C.I. Pigment Blue 15:4, C.I. Pigment Blue 16, C.I. Pigment Blue 17, C.I. Pigment Blue 60, C.I. Pigment Blue 62, C.I. Pigment Blue 66 and C.I. Pigment Green 7.

Dyes include C.I. Solvent Red 1, C.I. Solvent Red 49, C.I. Solvent Red 52, C.I. Solvent Red 58, C.I. Solvent Red 63, C.I. Solvent Red 111, C.I. Solvent Red 122, C.I. Solvent Yellow 2, C.I. Solvent Yellow 6, C.I. Solvent Yellow 14, C.I. Solvent Yellow 15, C.I. Solvent Yellow 16, C.I. Solvent Yellow 19, C.I. Solvent Yellow 21, C.I. Solvent Yellow 33, C.I. Solvent Yellow 44, C.I. Solvent Yellow 56, C.I. Solvent Yellow 61, C.I. Solvent Yellow 77, C.I. Solvent Yellow 79, C.I. Solvent Yellow80, Solvent Yellow 81, C.I. Solvent Yellow82, C.I. Solvent Yellow 93, C.I. Solvent Yellow 98, C.I. Solvent Yellow 103, C.I. Solvent Yellow 104, C.I. Solvent Yellow 112, C.I. Solvent Yellow 162, C.I. Solvent Blue 25, C.I. Solvent Blue 36, C.I. Solvent Blue 60, C.I. Solvent Blue 70, C.I. Solvent Blue 93 and C.I. Solvent Blue 95.

The foregoing colorants may be used alone or in combination. The colorant content is preferably from 1% to 30% by mass, and more preferably 2% to 20% by mass of the whole of a toner. A number average primary particle size, depending of its kind, is approximately from 10 to 200 nm.

A colorant is added, for example, at the time when resin particles are coagulated by a coagulant to color a polymer. The colorant particle surface may be treated by a coupling agent or the like.

There will described a wax usable in the invention. A wax usable in the invention includes commonly known wax and specific examples thereof include:

(1) Long chain hydrocarbon wax:

polyolefin wax such as polyethylene wax and polypropylene wax, paraffin wax and sazole wax;

### (2) Ester wax:

trimethylolpropane tribehenate, pentaerythritol tetramyristate, pentaerythritol tetrastearate, pentaerythritol tetrabehenate, pentaerythritol diacetate dibehenate, glycerin tribehenate, 1,18-octadecanediol stearate, trimellitic acid tristearate, and distearyl maleate;

(3) amide wax:

ethylenediamine dibehenylamide and trimellitic acid tristearylamide;

(4) dialkyl ketone wax:

distearyl wax;

(5) other wax:

Carnauba wax and montan wax.

The melting point of a wax is usual in the range of from 40 to 160° C., preferably from 50 to 120° C., and more preferably from 60 to 90° C. When a melting point falls within the foregoing range, heat resistance of a toner is secured and toner image formation is performed when fixing at low temperature. The content of a wax in a wax is preferably from 1 to 30% by mass, and more preferably fro 5 to 20% by mass.

Hereinafter, there will be described production methods of an electrophotographic toner related to the invention.

The toner related to the invention comprises at least a resin A and a resin B and can be produced by the methods known in the art. Typical methods of producing the toner related to the invention include, for example, a so-called emulsion aggregation method in which rein particles formed in an aqueous medium containing a surfactant are aggregated and fused in an aqueous medium to form toner particles. The emulsion aggregation method, which can prepare toner particles of uniform particle size or shape, is preferable for preparation of a toner used for digital image formation having opportunities of enhanced fine-line reproduction or fine-dot image formation.

Resin particles which are aggregated and fused in the emulsion aggregation method are produced in accordance with the following procedure. There are cited resin particles containing a resin A and a Resin B, resin A particles, and resin B particles. The resin particles containing a resin A and a Resin B are prepared in such a manner that first, fine resin B particles are formed and polymerization reaction is performed in the presence of the formed resin particles B to form a resin A, whereby enclosure structure type resin particles having a resin A phase bonded around a resin B phase are prepared. The resin A particles and the resin B particles are prepared by polymerizing a polymerizable monomers forming the individual resins.

The production method of a toner by emulsion aggregation is performed via the following steps:

(1) dissolution/dispersion step of dissolving and/or dispersing a wax in a radical polymerizable monomer,
(2) polymerization step of preparing a resin particle dispersion,
(3) aggregation/fusion step of aggregating and fusing resin particles and colorant particles to form aggregated particles,
(4) ripening step of ripening the aggregated particles with heat energy to control the particle form,
(5) separating step of separating the aggregated particles from a dispersion of aggregated particles to remove surfactants from the aggregated particles;
(6) drying step of the washed aggregated particles, and optionally after the drying step,
(7) a step of adding external additives to the dried aggregated particles.
The foregoing steps are each detailed later.

The aggregated particles forming parent particles are prepared by aggregation and fusion of resin particles and colorant particles. The shape of aggregated particles is controlled by adjusting the heating temperature in the aggregation/fusion step and the heating temperature and time in the first ripening step.

Of the foregoing, time control of the first ripening step is most effective. The ripening step aims to control the circularity degree of associated particles and the aggregated particles become a shape close to a circle by controlling the ripening step.

The aggregated particles forming parent particles are prepared preferably through salting-out/fusion. Specifically, a wax component is dissolved or dispersed in polymerizable monomers forming a resin and mechanically dispersed, and then, the polymerizable monomers are polymerized through mini-emulsion polymerization to form resin particles. The thus formed resin particles and colorant particles are subjected to salting-out/fusion to form aggregated particles. The foregoing dissolution of a wax component in a polymerizable monomer is performed by dissolving or melting the wax component.

In cases where toner particles have a core/shell structure, such toner particle can also be prepared in the same manner, except that, between the foregoing steps (4) and (5), the following steps are added:

(4-1) shelling step of adding particulate resin used for a shell to a dispersion of aggregated particles forming core particles (associated particles) to allow the resin used for a shell to be aggregated and fused onto the surface of the core particles to form parent toner particles exhibiting a core/shell structure,
(4-2) second ripening step for ripening the aggregated particles of a core/shell structure with heat energy to control the form of the aggregated particles of a core/shell structure.

The shelling step is a step to control final toner particle shape or size, in which resin particles used for shelling are added to core particles under the same condition. It is therefore essential to form core particles with uniform size and shape. A particulate resin is uniformly adhered to the surface of core particles to form a shell with uniform thickness, leading to formation of toner particles with uniform shape and size.

There will be described the respective steps in the production of a toner by the emulsion aggregation method.

### (1) Dissolution/Dispersion Step:

In this step, radical-polymerizable monomers to form a binder resin are mixed and dissolved to prepare a radical-polymerizable monomer solution and the thus prepared radical-polymerizable monomer solution is added to an aqueous medium and dispersed so that the monomer solution forms liquid drops of a prescribed size. In mixing radical-polymerizable monomer, plural kinds of radical-polymerizable monomers are mixed and a wax or the like is also dissolved in a radical-polymerizable monomer solution.

### (2) Polymerization Step:

In one preferred embodiment of this step, wax is added to an aqueous medium containing a surfactant at a concentration less than the critical micelle concentration (CMC) to form droplets, while providing mechanical energy. Subsequently, a water-soluble radical polymerization initiator is added thereto to promote polymerization within the droplets. An oil-soluble polymerization initiator may be contained in the droplets. In the polymerization step, providing mechanical energy is needed to perform enforced emulsification to form droplets. Means for providing mechanical energy include those for providing strong stirring or ultrasonic energy, for example, a homomixer, an ultrasonic homogenizer or a Manton-Gaulin homomixer.

Resin particles containing a binder resin and a wax are obtained in the polymerization step. The resin particles may be colored particles or non-colored ones. Colored particles can be obtained by polymerization of a monomer composition containing a colorant. In the case when using non-colored particles, in the aggregation/fusion step, a dispersion of colorant particles is added to a dispersion of resin particles to allow the resin particles and the colorant particles to be fused to prepare parent particles of a toner, so-called aggregated particles.

In the invention, resin particles comprising a resin A and a resin B are formed in the polymerization step. Specifically, preparation of resin particles containing a resin A and a resin B, or preparation of resin A particles and resin B particles is conducted.

The preparation of resin particles containing a resin A and a resin B is to prepare a dispersion of resin particles of a structure of enclosing a resin B phase with a resin A phase, in which a resin B is formed first and then, polymerization is performed in the presence of the resin B to form a resin A around the resin B. Preparation of the resin A and the resin B is to prepare a resin A particle dispersion and a resin B particle dispersion, respectively through polymerization.

### (3) Aggregation/Fusion Step:

A method for aggregation and fusion in the fusion step preferably is salting-out/fusion of resin particles (colored or non-colored resin particles) obtained in the above-described polymerization step. In the aggregation/fusion step, a particulate internal additive such as a particulate wax or charge-controlling agent may be aggregated/fused together with resin particles and colorant particles.

The salting-out/fusion means that aggregation and fusion are concurrently promoted and when grown to an intended particle size, a aggregation-terminating agent is added thereto to stop growth of the particles and heating optionally continues to control the particle shape.

The aqueous medium used in the aggregation/fusion step refers to a medium that is mainly composed of water (at 50% by weight or more). A component other than water is a water-soluble organic solvent. Examples thereof include methanol, ethanol, isopropanol, butanol, acetone, methyl ethyl ketone and tetrahydrofuran.

The colorant particles can be prepared by dispersing a colorant in an aqueous medium. Thus, a colorant is dispersed in an aqueous medium containing surfactants at a concentration in water at least the critical micelle concentration (CMC). Dispersing machines used for dispersing the colorant are not specifically limited but preferably pressure dispersing machines such as an ultrasonic disperser, a mechanical homogenizer, a Manton-Gaulin homomixer or a pressure homogenizer, and a medium type dispersing machines such as a sand grinder, a Gettsman mil or a diamond fine mill. Usable surfactants include those described later. The colorant particles may be those which have been subjected to surface modification treatments. Surface modification of the colorant particles is affected, for example, in the following manner. A colorant is dispersed in a solvent and thereto, a surface-modifying agent is added and allowed to react with heating. After completion of the reaction, the colorant is filtered off, washed with the same solvent and dried to produce a surface-modified colorant (pigment).

The process of salting-out/fusion as a preferred method of aggregation/fusion is conducted, for example, in the following manner. To water containing resin particles and colorant particles is added an agent for salting out (hereinafter, also denoted as salting-out agent), e.g., alkali metal salts, alkaline earth metal salts or trivalent metal salts, at a concentration higher than the critical aggregation concentration. Subsequently, the mixture is heated at a temperature (° C.) higher than the glass transition temperature of the resin particles and also higher than the melting peak temperature to promote fusion concurrently with salting out. Of alkali metal salts and alkaline earth metal salts, alkali metals include, for example, lithium, potassium and sodium; and alkaline earth metals include magnesium calcium, strontium, and barium, of which potassium, sodium, magnesium, calcium and barium are preferred.

When performing aggregation and fusion through salting out and fusion, the mixture after adding a salting-out agent is permitted to stand preferably as short a time as possible. The reason therefor is not totally clear but there were produced problems such that the aggregation state of particles varied, the particle size distribution became unstable or the surface property of fused toner particles varied, depending on the standing time after being salted out. Addition of a salting-out agent needs to be conducted at a temperature lower than the glass transition temperature of the resin particles. The reason therefor is that addition of a salting-out agent at a temperature higher than the glass transition temperature promotes salting out and fusion of the resin particles but cannot control the particle size, resulting in formation of larger sized particles. The addition temperature, which is lower than the glass transition temperature, is usually in the range of 5 to 55° C., and preferably 10 to 45° C.

A salting-out agent is added at a temperature lower than the glass transition temperature of the resin particles and subsequently, the temperature is promptly increased to a temperature higher than the glass transition temperature of the resin particles and also higher than the melting peak temperature (° C.) of the mixture. The temperature is increased preferably over a period of less than 1 hr. The temperature needs to be promptly increased, preferably at a rate of 0.25° C./min or more. The upper temperature limit is not definite but instantaneously increasing the temperature abruptly causes salting out, rendering it difficult to control the particle size. The temperature is increased preferably at a rate of 5° C./min or less. In the fusion step, resin particles and any other particles are subjected to salting-out/fusion to obtain a dispersion of associated particles (core particles).

### (4) Ripening Step:

Subsequently, the heating temperature in the aggregation/fusion step and the heating temperature and time in the first ripening step is so controlled that the formed core particles are in the shape of being rugged. Concretely, the aggregation/fusion step is conducted at a relatively low heating temperature to retard the progress of resin particles being fused to each other, which promotes deformation, or the first ripening is controlled at a low heating temperature for a long period so that the formed core particles are in the form of being relatively uniform

### (4-1) Shelling Step:

In the shelling step, a dispersion of a particulate resin to be used for shelling is added to a dispersion of core particles and the resin particles for shelling coagulate and fuse with each other to permit the particulate resin to cover the surface of core particles, resulting in formation of colored particles. Specifically, a core particle dispersion is added to a dispersion of resin particles for shelling, while maintaining the temperature in the aggregation/fusion step and the first ripening step and stirring with heating further continues for several hours, while the resin particles are permitted to cover the core particle surface to form colored particles. The time for stirring with heating is preferably 1 to 7 hrs., and more preferably 3 to 5 hrs.

### (4-2) Second Ripening Step:

When the colored particles reach the prescribed size through shelling, a stopping agent such as sodium chloride is added thereto to stop growth of particles. Thereafter, stirring with heating continues further for several hours to permit the resin particles to fuse onto the core particles. In the shelling step, a 10 to 500 nm thick shell is formed on the core particle surface. Thus, resin particles are fixed by melting together onto the core particle surface to form a shell, whereby round, uniform colored particles are formed. Further, the shape of colored particles can be controlled to be close to a sphere by extending the second ripening time or by raising the ripening temperature.

### (5) Washing Step:

This step refers to a stage that subjects a dispersion of the foregoing colored particles to a cooling treatment (rapid cooling). Cooling is performed at a cooling rate of 1 to 20° C./min. The cooling treatment is not specifically limited and examples thereof include a method in which a refrigerant is introduced from the exterior of the reaction vessel to perform cooling and a method in which chilled water is directly supplied to the reaction system to perform cooling.

Subsequently, a solid-liquid separation treatment of separating colored particles from a colored particle dispersion is conducted, then cooled to the prescribed temperature in the foregoing step and a washing treatment for removing adhered material such as a surfactant or salting-out agent from a separated toner cake (wetted aggregate of colored particles aggregated in a cake form) is applied. In this step, a filtration treatment is conducted, for example, by a centrifugal separation, filtration under reduced pressure using a Nutsche funnel or filtration using a filter press, but is not specifically limited.

### (6) Drying Step:

In this step, the washed toner cake is subjected to a drying treatment to obtain dried colored particles. Drying machines usable in this step include, for example, a spray dryer, a vacuum freeze-drying machine, or a vacuum dryer. Preferably used are a standing plate type dryer, a movable plate type dryer, a fluidized-bed dryer, a rotary dryer or a stirring dryer. The moisture content of the dried colored particles is preferably not more than 5% by weight, and more preferably not more than 2%. When colored particles that were subjected to a drying treatment are aggregated via a weak attractive force between particles, the aggregate may be subjected to a pulverization treatment. Pulverization can be conducted using a mechanical pulverizing device such as a jet mill, Henschel mixer, coffee mill or food processor.

### External Addition Treatment:

In this step, the dried coalesced particles are optionally mixed with external additives to prepare toner particles.

Coalesced particles which were prepared via steps up to the drying step may be usable as toner particles but it is preferable to add, as an external additive, commonly know inorganic or organic particles to the surfaces of coalesced particles to achieve an enhancement of electrostatic-charging performance, flowability or cleaning property as a toner.

The kind of such external additives is not specifically limited but examples thereof include inorganic particles, organic particles and slipping agents, as below.

As inorganic particles are usable commonly known ones and preferred examples thereof include silica, alumina and strontium titanate particles. Such inorganic particles may optionally be subjected to a hydrophobilization treatment by use of a silane coupling agent or a titanium coupling agent.

Specific examples of silica particles include R-805, R-976, R-974, R-972, R-812 and R-809 which are commercially available from Nippon Aerosil Co., Ltd.; HVK-2150 and H-200 which are commercially available from Hoechst Co.; TS-720, TS-530, TS-610, H-5 and MS-5 which is commercially available from Cabot Co.

Examples of titania particles include T-805 and T-604 which are commercially available from Nippon Aerosil Co. Ltd.; MT-100S, MT-100B, MT-500BS, MT-600, MT-600SJA-1 which are commercially available from Teika Co.; TA-300SI, TA-500, TAF-130, TAF-510 and TAF-510T which as commercially available from Fuji Titan Co., Ltd.; IT-S, IT-OB and IT-OC which as commercially available from Idernitsu Kosan Co., Ltd.

Examples of alumina particles include RFY—C and C-604 which are commercially available from Nippon Aerosil Co., Ltd.; and TTO-55, commercially available from Ishihara Sangyo Co., Ltd.

Spherical organic microparticles having a number-average primary particle size of 10 to 2000 nm are usable as organic microparticles. Specifically, there is usable styrene or methyl methacrylate homopolymer or their copolymers.

There are also usable lubricants, such as long chain fatty acid metal salts to achieve enhanced cleaning ability or transferability. Examples of a long chain fatty acid metal salt include zinc, copper, magnesium, and calcium stearates; zinc, manganese, iron, copper and magnesium oleates; zinc, copper, magnesium, and calcium palmitates; zinc and calcium linolates; zinc and calcium ricinolates.

Such an external additive or lubricant is incorporated preferably in an amount of 0.1 to 10.0% by weight of the total toner. The external additive or lubricant can be incorporated by using commonly known mixing devices such as a turbuler mixer, a HENSCHEL MIXER, a Nauter mixer or a V-shape mixer.

There will be described a polymerization initiator, a dispersion stabilizer and a surfactant usable in preparation of the toner relating to the invention by a process of emulsion association.

There are usable commonly known oil-soluble or water-soluble polymerization initiators when forming a binder resin of the toner relating to the present invention. Examples of an oil-soluble polymerization initiator include azo- or diazo-type polymerization initiators and peroxide polymerization initiators. Specific examples thereof include

(1) azo- or diazo-type polymerization initiators:

2,2′-azobis-(2,4-dimethylvaleronitrile), 2,2′-azobisisobutylonitrile, 1,1′-azobis(cyclohexane-1-carbonitrile), 2,2′-azobis-4-methoxy-2,4-dimethylvaleronitrile, azobisisobutylonitrile, and

(2) peroxide type polymerization initiators:

benzoyl peroxide, methyl ethyl ketone peroxide, diisopropylperoxycarbonate, cumene hydroperoxide, t-butyl hyroperoxide, di-t-butyl peroxidedicumyl peroxide, 2,4-dichlorobenzoyl peroxide, lauroyl peroxide, 2,2-bis-(4,4-t-butylperoxycyclohexyl)-propane, tris-(t-butylperoxy)triazine.

Water-soluble radical polymerization initiators are usable when forming particulate resin through emulsion polymerization. Examples of a water-soluble polymerization initiator include persulfates such as potassium persulfate and ammonium persulfate; azobisaminodipropane acetic acid salt, azobiscyanovaleric acid and its salt, and hydrogen peroxide.

Conventionally used chain-transfer agents are usable for the purpose of adjustment of the molecular weight of resin constituting composite resin particles. Chain-transfer agents are not specifically limited and examples thereof include mercaptans such as octylmercaptan, dodecylmercaptan and tert-dodecylmercaptan; n-octyl-3-mercaptopropionic acid ester; terpinolene; carbon tetrabromide and α-methylstyrene dimmer.

In the present invention, a tone is prepared in such a manner that polymerizable monomers which are dispersed in an aqueous medium are allowed to polymerize in a stable state, or resin particles which are dispersed in an aqueous medium are allowed to stably coagulate and fuse. It is therefore preferable to use a dispersion stabilizer to allow these material to be stably dispersed in the aqueous medium. Examples of a dispersion stabilizer include calcium phosphate, magnesium phosphate, zinc phosphate, aluminum phosphate, calcium carbonate, magnesium carbonate, calcium hydroxide, magnesium hydroxide, aluminum hydroxide, calcium metasilicate, calcium sulfate, barium sulfate, bentonite, silica and alumina. Further, polyvinyl alcohol, gelatin, methylcellulose, sodium dodecybenzenesulfate, ethylene oxide adduct, sodium higher alcohol-sulfate and the like, which are generally usable as a surfactant, are also usable as a dispersion stabilizer.

To perform polymerization of polymerizable monomers in an aqueous medium, surfactants are used to disperse such monomers in the form of oil droplets in an aqueous medium. Surfactants usable therein are not specifically limited but ionic surfactants described below are preferred. Such ionic surfactants include, for example, sulfonates, sulfuric acid ester salts and carboxylic acid salts. Examples of sulfonates include sodium dodecylbenzenesulfate, sodium arylalkylpolyethersulfonate, sodium 3,3-disulfondisphenylurea-4,4-diazo-bis-amino-8-naphthol-6-sulfonate, ortho-carboxybenzene-azo-dimethylaniline, sodium 2,2,5,5-tetramethyl-triphenylmethane-4,4-diazo-bis-□-naphthol-6-sulfonate.

Examples of a sulfuric acid ester salt include sodium dodecylsulfonate, sodium tetradecylsulfonate, sodium pentadecylsulfonate, and sodium octylsulfonate. Specific examples of a carboxylate include carboxylates sodium oleate, sodium laurate, sodium caprate, sodium caprylate, sodium caproate, potassium stearate and calcium oleate.

Nonionic surfactants are also usable. Examples thereof include polyethylene oxide, polypropylene oxide, a combination of polypropylene oxide and polyethylene oxide, an ester of polyethylene glycol and a higher fatty acid, alkylphenol polyethylene oxide, an ester of polypropylene oxide and a higher fatty acid, and sorbitan ester.

Hereinafter, there will be described a developer using the toner related to the invention. Toners relating to the invention are usable as a single component developer (inclusive of magnetic and nonmagnetic ones) which performs image formation without using a carrier and as a two component developer which performs image formation with using a carrier.

A two component developer is prepared by mixing a toner and magnetic particles as a carrier. A toner content is preferably 2 to 10% by mass, based on carrier. A mixer usable in the present invention is not specifically limited, including, for example, a Nauter mixer and a W-cone or V-shape mixer.

A volume average particle size of a carrier is preferably from 20 to 60 μm, and a magnetic saturation susceptibility is preferably from 20 to 80 emu/g. The use of a carrier exhibiting such a particle size and a magnetic saturation susceptibility enables to form a soft magnetic brush on a development sleeve at the time of development, leading to formation of a toner image exhibiting superior sharpness.

The above-described volume-based average particle size and magnetic saturation susceptibility can be determined by a measurement instrument known in the art. Specifically, the volume-based average particle size can be measured by laser diffraction sensor HELOS (produced by SYMPATECS Co., Ltd.) which is installed with a wet disperser, and the saturation susceptibility can be measured by, for example, direct current susceptibility automatic recorder 3257-35 (produced by Yokokawa Denku Co., Ltd.).

There is preferred a carrier in which magnetic particles are used as a core and the core surface is covered with a resin. Resin used for coverage of the core is not specifically limited and a variety of resins are usable. There are usable, for example, a fluororesin, fluoro-acryl resin, silicone resin and modified silicone resin for a positive charged toner, and a condensed silicone resin specifically preferred. There are also usable for a negative-charged toner, for example, an acryl-styrene resin, a mixed resin of an acryl-styrene resin and a melamine resin and its cured resin, silicone resin, modified silicone resin, an epoxy resin, polyester resin, a urethane resin, and a polyethylene resin; of these are preferred a mixed resin of an acryl-styrene resin and a melamine resin and its cured resin and condensed silicone resin. There may optionally incorporated a charge controlling agent, a contact-enhancing agent, a primer treating agent or a resistance controlling agent.

When used as a nonmagnetic single-component developer without a carrier to perform image formation, a toner is charged with being rubbed or pressed onto a charging member or the developing roller surface. Image formation in a nonmagnetic single-component development system can simplify the structure of a developing device, leading to a merit of compactification of the whole image forming apparatus. Therefore, the use of the toner of the invention as a single-component developer can achieve full-color printing in a compact printer, making it feasible to prepare full-color prints of superior color reproduction even in a space-limited working environment.

A magnetic toner as one of single-component developer may be prepared by using fine magnetic particles as a colorant. There are used magnetic particles of ferrite or magnetite having an average primary particle size of 0.1 to 2.0 μm. Such magnetic particles are contained in an amount of 20 to 70% by mass, based on toner.

Inorganic particles known in the art may be mixed in terms of providing flowability. Inorganic particles of silica, titania or alumina are preferable and preferably, such inorganic particles are hydrophobilized with a silane coupling agent or a titanium coupling agent.

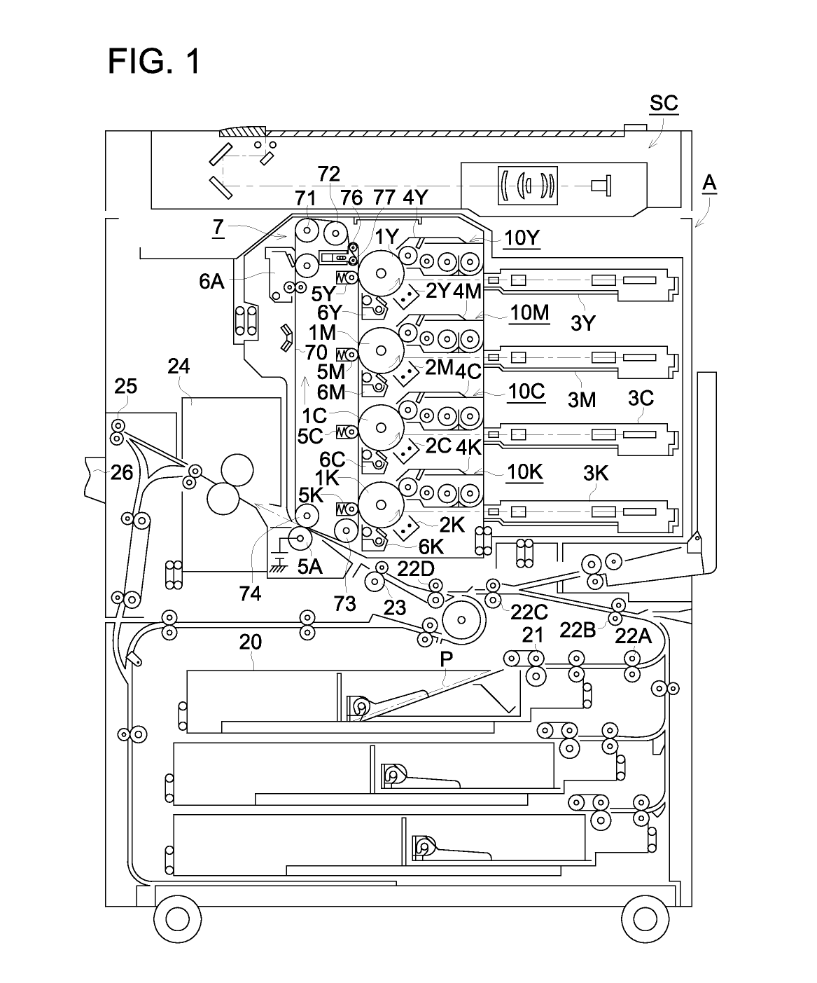

Hereinafter, there will be described an image forming apparatus in which image formation can be performed by using the toner related to the invention. FIG. 1 shows a schematic sectional view of an exemplary image forming apparatus usable when the toner related to the invention is used as a two-component developer.

In FIG. 1, designations 1Y, 1M, 1C and 1K are each a photoreceptor; 4Y, 4M, 4C and 4K are each a developing device; 5Y, 5M, 5C and 5K are each a primary transfer roll as a primary transfer means; 5A is a secondary transfer roll as a secondary transfer means; 6Y, 6M, 6C and 6K are each a cleaning device; 7 is an intermediate transfer unit, 24 is a heat roll type fixing device, and 70 is an intermediate transfer body unit.

This image forming apparatus is called a tandem color image forming apparatus, which is, as a main constitution, comprised of plural image forming sections 10Y, 10M, 10C and 10Bk; an intermediate transfer material unit 7 of an endless belt form, a paper feeding and conveying means 21 to convey a recording member P and a heat-roll type fixing device 24 as a fixing means. Original image reading device SC is disposed in the upper section of an image forming apparatus body A.

As one of different color toner images of the respective photoreceptors, image forming section 10Y to form a yellow image comprises a drum-form photoreceptor 1Y as the first photoreceptor; an electrostatic-charging means 2Y, an exposure means 3Y, a developing means 4Y, a primary transfer roller 5Y as a primary transfer means; and a cleaning means 6Y, which are disposed around the photoreceptor 1Y. As another one of different color toner images of the respective photoreceptors, image forming section 10M to form a magenta image comprises a drum-form photoreceptor 1M as the first photoreceptor; an electrostatic-charging means 2M, an exposure means 3M, a developing means 4M, a primary transfer roller 5M as a primary transfer means; and a cleaning means 6M, which are disposed around the photoreceptor 1M.

Further, as one of different color toner images of the respective photoreceptors, image forming section 10C to form a cyan image comprises a drum-form photoreceptor 1C as the first photoreceptor; an electrostatic-charging means 2C, an exposure means 3C, a developing means 4C, a primary transfer roller 5C as a primary transfer means; and a cleaning means 6C, which are disposed around the photoreceptor 1C. Furthermore, as one of different color toner images of the respective photoreceptors, image forming section 10K to form a cyan image comprises a drum-form photoreceptor 1K as the first photoreceptor; an electrostatic-charging means 2K, an exposure means 3K, a developing means 4K, a primary transfer roller 5K as a primary transfer means; and a cleaning means 6K, which are disposed around the photoreceptor 1K.

Intermediate transfer unit 7 of an endless belt form is turned by plural rollers and has intermediate transfer material 70 as the second image carrier of an endless belt form, while being pivotably supported.

The individual color images formed in image forming sections 10Y, 10M, 10C and 10K are successively transferred onto the moving intermediate transfer material (70) of an endless belt form by primary transfer rollers 5Y, 5M, 5C and 5K, respectively, to form a composite color image. Recording member P of paper or the like, as a final transfer material housed in a paper feed cassette 20, is fed by paper feed and a conveyance means 21 and conveyed to a secondary transfer roller 5b through plural intermediate rollers 22A, 22B, 22C and 22D and a resist roller 23, and color images are secondarily transferred together on the recording member P. The color image-transferred recording member (P) is fixed by a heat-roll type fixing device 8, nipped by a paper discharge roller 25 and put onto a paper discharge tray 26 outside a machine.

After a color image is transferred onto the recording member P by a secondary transfer roller 5A as a secondary transfer means, an intermediate transfer material 70 of an endless belt form which separated the recording material P removes any residual toner by cleaning means 6A.

During the image forming process, the primary transfer roller 5K is always in contact with the photoreceptor 1K. Other primary transfer rollers 5Y, 5M and 5C are each in contact with the respectively corresponding photoreceptors 1Y, 1M and 1C only when forming a color image.

The secondary transfer roller 5A is in contact with the intermediate transfer material 70 of an endless belt form only when the recording member P passes through to perform secondary transfer.

Image forming sections 10Y, 10M, 10C and 10K are aligned vertically. The endless belt intermediate transfer material unit 7 is disposed on the left side of photoreceptors 1Y, 1M, 1C and 1K. The intermediate transfer material unit 7 comprises the endless belt intermediate transfer material 70 which can be turned via rollers 71, 72, 73, 74, 76 and 77 primary transfer rollers 5Y, 5M, 5C and 5K and cleaning means 6A.

Thus, toner images are formed on the photoreceptors 1Y, 1M, 1C and 1K via charging, exposure and development, toner images of the respective colors are superimposed on the endless belt intermediate transfer material 70, transferred together to the recording member P and fixed by applying pressure with heating in the fixing device 8. After having transferred the toner image onto the recording member P, the photoreceptor 1Y, 1M, 1C and 1K are each cleaned in cleaning devices 6Y, 6M, 6C and 6K to remove a remained toner and enter the next cycle of charging, exposure, and development to perform image formation.

In an image forming method in cases when using the toner related to the invention as a non-magnetic single-component developer, the foregoing two-component developing device is replaced by a single-component developing device.

In FIG. 1 is shown a fixing device of a roller fixing type constituted of a heating roller and a pressure roller. In the invention, however, fixing methods are not specifically restricted and there are usable heretofore known fixing systems, including, for example, a roller fixing system described above, a fixing system constituted of a heating roller and a pressure belt, a fixing system constituted of a heating belt and a pressure roller, and a belt fixing system constituted of a heating belt and a pressure belt. Further, a heating system may employ heating systems known in the art, such as a system by use of a halogen lamp oral fixing system.

Recording paper on which images can be formed by use of the toner related to the invention is generally called a transfer material or an image support and is not specifically restricted but any one capable of supporting images formed through commonly known image forming methods by, for example, an image forming apparatus, as described above. Specific examples thereof include plain paper inclusive of thin and thick paper, fine-quality paper, coated paper used for printing, such as art paper or coated paper, commercially available Japanese paper and postcard paper, plastic film used for OHP (overhead projector) and cloth, but are not limited to the foregoing.

### Examples

Hereinafter, the present invention will be further described with reference to examples, but the embodiments of the invention are by no means limited to them. In the following examples, “part(s)” represents part(s) by mass unless otherwise noted.

### Preparation of Toner

### 1-1 Preparation of Toner 1

### (1) Preparation of Resin Microparticle A1B1 Dispersion:

There were prepared resin microparticles having a structure of enclosing a resin B within a resin A. Namely, in accordance with the procedure described below, a styrenic monomer and a (meth)acrylic monomer were supplied in the presence of microparticulate resin B to undergo polymerization to prepare resin microparticles of a structure of causing a resin B to be enclosed within a resin A.

### (a) Preparation of Microparticulate Resin B1 Dispersion (First Polymerization Step):

In a reaction vessel fitted with a stirrer, a temperature sensor, a condenser and a nitrogen-introducing device, 2 parts by mass of an anionic surfactant (sodium dodecylbenzenesulfonate, SDS) were dissolved in 2900 parts by mass of deionized water to prepare an aqueous surfactant solution. The aqueous surfactant solution was heated to a temperature of 80° C., while stirring at a rate of 230 rpm under a stream of nitrogen.

After adding 9.0 parts by mass of potassium persulfate (KPS) to the foregoing aqueous surfactant solution, a monomer solution composed of the compounds described below was dropwise added thereto.

| | |
|---|---|
| n-Butyl acrylate | 198 parts |
| Methyl methacrylate | 945 parts |
| Itaconic acid | 60 parts |

After completing addition of the monomer solution, the reaction mixture was maintained at 78° C. for one hour to promote polymerization reaction to prepare a dispersion of microparticulate copolymer resin B1 formed of the above-described three polymerizable monomers. The proportion of methyl methacrylate and itaconic acid in the copolymer constituting the microparticulate resin B1 was 83.5% by mass. The weight average molecular weight (Mw) of the microparticulate resin B1 was 300,000 and its glass transition temperature (Tg) was 70° C.

### (b) Second Polymerization Step:

In 110 parts by mass of deionized water were dissolved 2 parts by mass of an anionic surfactant [polyoxy(2)dodecy ether sulfuric acid ester sodium salt] to prepare a surfactant solution. Further, compounds described below were dropwise added over 5 minutes into a flask fitted with a stirrer and heated to 85° C. to prepare a monomer solution.

| | |
|---|---|
| Styrene | 230 parts |
| n-Butyl acrylate | 103 parts |
| Methacrylic acid | 19 parts |
| n-Octylmercaptan | 4 parts |
| Paraffin wax (WBM-1) | 190 parts |

After the foregoing surfactant solution was heated to 90°αC., 75 parts by mass of the foregoing dispersion of microparticulate resin B1 and the monomer solution were added thereto and mixed with stirring in a mechanical disperser provided with a circulation path, CLEARMIX (produced by M-Technique Co., Ltd.) over four hours to prepare a dispersion.

To the thus prepared dispersion was added an aqueous polymerization initiator solution of 15 parts by mass of potassium persulfate (KPS) dissolved in 211 parts by mass of deionized water and stirred at 90° C. for two hours to promote polymerization reaction to prepare a dispersion of particulate resin a1B1.

### (c) Third Polymerization Step:

To the dispersion of particulate resin a1B1 were added 7 parts by mass of potassium persulfate and 184 parts by mass of deionized water and heated to 80° C. Then, compounds described below were dropwise added thereto.

| | |
|---|---|
| Styrene | 415 parts |
| n-Butyl acrylate | 156 parts |
| n-Octylmercaptan | 7.5 parts |

After completing the addition, stirring continued at 80° C. for two hours to promote polymerization reaction and then the reaction mixture was cooled to 28° C. There was thus formed a resin A1 constituted of a copolymer formed by allowing a styrenic monomer and a (meth)acrylic monomer to polymerize in the presence of the resin B, whereby a dispersion of particulate resin A1B1 was prepared which contained resin particles having a structure of the resin B1 being enclosed within the resin A1. The particulate resin B1 content was 7.5% by mass of particulate resin A1B1.

Further, the foregoing second polymerization step and the third polymerization step were conducted under the condition of the microparticulate resin B1 being absent to form a particulate resin A1 and it was proved that such a particulate resin A1 exhibited a weight average molecular weight of 20,000 and a glass transition temperature of 40° C.

### (2) Preparation of Resin Microparticle C1 Dispersion:

Into a reaction vessel fitted with a stirrer, a temperature sensor, a condenser and a nitrogen-introducing device were 2 parts by mass of an anionic surfactant (sodium dodecylbenzenesulfonate, SDS) dissolved in 2900 parts by mass of deionized water to prepare an aqueous surfactant solution. The aqueous surfactant solution was heated to a temperature of 80° C., while stirring at a rate of 230 rpm under a stream of nitrogen.

After adding 9.0 parts by mass of potassium persulfate (KPS) to the foregoing aqueous surfactant solution, a monomer solution composed of the compounds described below was dropwise added thereto.

| | |
|---|---|
| Styrene | 516 parts |
| n-Butyl acrylate | 204 parts |
| Methyl methacrylate | 100 parts |
| n-Octylmercaptan | 22 parts |

After completing the addition of the monomer solution, the reaction mixture was maintained at 78° C. for one hour to promote polymerization reaction to prepare a dispersion containing microparticulate resin C.

### (3) Preparation of Colorant Microparticle Dispersion:

To an aqueous solution of 90 parts by mass of sodium dodecylsulfate dissolved in 1600 parts by mass of deionized water were gradually added 229 parts by mass of colorant PIGMENT BLUE DOWFAX 2A-1 with stirring and then dispersed by a mechanical disperser, CLEARMIX to prepare a colorant microparticle dispersion. The mass average particle size of colorant microparticles contained of the thus prepared colorant microparticle dispersion, which was measured with an electrophoretic light scattering photometer (ELS-800, produced by Otsuka Denshi Co., Ltd), was proved to be 110 m.

### (4) Preparation of Toner 1:

### (a) Palmation of Core:

Into a reaction vessel fitted with a stirrer, a temperature sensor and a condenser was added the composition described below with stirring to prepare a dispersion.

| | | |
|---|---|---|
| Particulate resin A1B1 dispersion | 430 | parts (solid content) |
| Deionized water | 1650 | parts |
| Colorant microparticle dispersion | 150 | parts |

The pH of the thus prepared dispersion was adjusted 102 with an aqueous 25% sodium hydroxide solution. The foregoing 430 parts (solid content) of particulate resin A1B1 dispersion contained 32.25 parts by mass (as a solid) of the microparticulate resin B1.

Subsequently, 150 parts by mass of aqueous magnesium chloride hexahydrate (50% by mass) was added to the foregoing dispersion over 20 minutes, while stirring. After completing the addition of the aqueous magnesium chloride hexahydrate, the temperature was raised to 80° C. over 60 minutes to undergo aggregation and fusion of the microparticles. Under this state, the size of coalesced particles was measured by MULTISIER 3 (produced by Beckman Coulter Co.) When the volume-based median diameter of coalesced particles reached 6.5 μm, 100 parts by mass of aqueous 25% by mass sodium chloride was added to terminate growth of the particles. Thereafter, ripening was conducted at 83° C. over 2 hours to control the particle shape, whereby core particles were formed.

### (b) Formation of Shell:

A dispersion of the foregoing core particles was maintained at 83° C. and thereto, 50 parts by mass (solid content) of the foregoing particulate resin dispersion C was added over 20 minutes. After completing addition, stirring continued over 2 hours to allow the resin particles to be aggregated and fused onto the core particle surface. Thereafter, fusing treatment continued over 30 minutes to perform shell formation.

### (c) Post-Treatment

After completing the foregoing shell formation, 200 parts by mass of an aqueous 25% by mass sodium chloride solution to terminate the fusing treatment and then, the mixture was heated to 88° C. to perform ripening. The thus formed particle dispersion was cooled at a rate of 4° C./min, then washed with 20° C. deionized water and dried under room temperature to prepare toner parent particle 1 having a core/shell structure.

To the thus prepared toner parent particle 1, external additives described below were added and subjected to an external treatment in a Henshell mixer to prepare a toner 1.

| | |
|---|---|
| Hexamethylsilazane-treated silica | 0.6 part |
| (average primary particle size: 12 nm) | |
| n-Octylsilane-treated titanium dioxide | 0.8 part |
| (average primary particle size: 24 nm) | |

The external treatment in a Henshell mixer was conducted under the condition of a circumference rate of the stilling blade of 35 msec and treatment temperature of 35° C. over a treatment time of 15 minutes.

### 1-2 Preparation of Toners 2-18:

### (1) Preparation of Toners, 2, 3, 16 and 17:

### (a) Preparation Toner 2:

A dispersion of microparticulate resin B2 was prepared in the same manner as the dispersion of microparticulate resin B1 used for preparation of the toner 1, except that amounts of the compounds used therein were varied as below:

| | |
|---|---|
| n-Butyl acrylate | 60 parts |
| Methyl methacrylate | 1075 parts |
| Itaconic acid | 68 parts |

The proportion of methyl methacrylate and itaconic acid in the copolymer constituting the microparticulate resin B1 was 95% by mass. The weight average molecular weight (Mw) and glass transition temperature (Tg) of the microparticulate resin B2 were the same as those of the microparticulate resin B1. A dispersion of microparticulate resin A1B2 was prepared in the same manner as the dispersion of microparticulate resin A1B1, except that a dispersion of microparticulate B2 was used in place of a dispersion of microparticulate resin B1. Toner 2 was prepared in the same manner as the toner 1, except that a dispersion of microparticulate resin A1B2 was used in place of a dispersion of microparticulate resin A1B1.

### (b) Preparation of Toner 3:

A dispersion of microparticulate resin B3 was prepared in the same manner as the dispersion of microparticulate resin B1 used for preparation of the toner 1, except that amounts of the compounds used therein were varied as below:

| | |
|---|---|
| n-Butyl acrylate | 361 parts |
| Methyl methacrylate | 792 parts |
| Itaconic acid | 50 parts |

The proportion of methyl methacrylate and itaconic acid in the copolymer constituting the microparticulate resin B3 was 70% by mass. The weight average molecular weight (Mw) and glass transition temperature (Tg) of the microparticulate resin B3 were the same as those of the microparticulate resin B1. A dispersion of microparticulate resin A1B3 was prepared in the same manner as the dispersion of microparticulate resin A1B1, except that a dispersion of microparticulate resin B3 was used in place of the dispersion of microparticulate resin B1. Toner 3 was prepared in the same manner as the toner 1, except that a dispersion of microparticulate resin A1B3 was used in place of the dispersion of microparticulate resin A1B1.

### (c) Preparation of Toner 16:

A dispersion of microparticulate resin B9 was prepared in the same manner as the dispersion of microparticulate resin B1, used for preparation of the toner 1, except that amounts of the compounds used therein were varied as below:

| | |
|---|---|
| n-Butyl acrylate | 421 parts |
| Methyl methacrylate | 735 parts |
| Itaconic acid | 47 parts |

The proportion of methyl methacrylate and itaconic acid in the copolymer constituting the microparticulate resin B9 was 65% by mass. The weight average molecular weight (Mw) and glass transition temperature (Tg) of the microparticulate resin B3 were the same as those of the microparticulate resin B1. A dispersion of microparticulate resin A1B9 was prepared in the same manner as the dispersion of microparticulate resin A1B1, except that a dispersion of microparticulate resin B9 was used in place of the dispersion of microparticulate resin B1. Toner 16 was prepared in the same manner as the toner 1, except that the dispersion of microparticulate resin A1B9 was used in place of the dispersion of microparticulate resin A1B1.

### (d) Preparation Toner 17:

A dispersion of microparticulate resin B10 was prepared in the same manner as the dispersion of microparticulate resin B1 used for preparation of the toner 1, except that amounts of the compounds used therein were varied as below:

| | |
|---|---|
| n-Butyl acrylate | 12 parts |
| Methyl methacrylate | 1120 parts |
| Itaconic acid | 71 parts |

The proportion of methyl methacrylate and itaconic acid in the copolymer constituting the microparticulate resin B10 was 99% by mass. The weight average molecular weight (Mw) and glass transition temperature (Tg) of the microparticulate resin B10 were the same as those of the microparticulate resin B1. A dispersion of microparticulate resin A1B10 was prepared in the same manner the dispersion of microparticulate resin A1B1, except that a dispersion of microparticulate resin B10 was used in place of the dispersion of microparticulate resin B1. Toner 17 was prepared in the same manner as the toner 1, except that the dispersion of microparticulate resin AlB10 was used in place of the dispersion of microparticulate resin A1B1.

### (2) Preparation of Toners 4 and 5:

### (a) Preparation Toner 4:

Toner 4 was prepared in the same manner as the toner 1, except that the dispersion of microparticulate resin A1B1 was replaced by a dispersion of microparticulate resin A2B1; provided that the dispersion of microparticulate resin A2B1 was prepared in the same manner as the dispersion of microparticulate resin A1B1, except that amounts of the compounds used in the second and third polymerization steps in preparation of the dispersion of microparticulate resin A1B1 were changed as follows:

### Second Polymerization Step:

| | |
|---|---|
| Styrene | 208 parts |
| n-Butyl acrylate | 123 parts |
| Methacrylic acid | 21 parts |
| n-Octylmercaptan | 6.7 parts |
| Paraffin wax (WBM-1) | 190 parts |

### Third Polymerization Step:

| | |
|---|---|
| Styrene | 383 parts |
| n-Butyl acrylate | 187 parts |
| n-Octylmercaptan | 9.5 parts |

To confirm physical properties of a resin A2, microparticulate resin A2 were prepared, provided that the second and third polymerization steps were conducted in the absence of the microparticulate resin B1, and it was proved that its weight average molecular weight (Mw) and glass transition temperature (Tg) were 10,000 and 30° C., respectively. Further, toner 4 was prepared in the same manner as the foregoing toner 1, except that core formation was conducted by using the dispersion of microparticulate resin A2B1 in place of the dispersion of microparticulate resin A1B1.

### (b) Preparation Toner 5:

Toner 5 was prepared in the same manner as the toner 1, except that the dispersion of microparticulate resin A1B1 was replaced by a dispersion of microparticulate resin A3B1; provided that the dispersion of microparticulate resin A3B1 was prepared in the same manner as the dispersion of microparticulate resin A1B1, except that amounts of the compounds used in the second and third polymerization steps in preparation of the dispersion of microparticulate resin A1B1 were changed as follows:

### Second Polymerization Step:

| | |
|---|---|
| Styrene | 250 parts |
| n-Butyl acrylate | 84 parts |
| Methacrylic acid | 18 parts |
| n-Octylmercaptan | 4 parts |
| Paraffin wax (WBM-1) | 190 parts |

### Third Polymerization Step:

| | |
|---|---|
| Styrene | 445 parts |
| n-Butyl acrylate | 22 parts |
| n-Octylmercaptan | 7 parts |

To confirm physical properties of a resin A3, microparticulate resin A3 was prepared, provided that the second and third polymerization steps were conducted in the absence of microparticulate resin B1, and it was proved that its weight average molecular weight (Mw) and glass transition temperature (Tg) were 30,000 and 50° C., respectively. Further, toner 5 was prepared in the same manner as the foregoing toner 1, except that formation of core particles was conducted by using the dispersion of microparticulate resin A3B1 in place of the dispersion of microparticulate resin A1B1.

### (3) Preparation of Toners 6, 7, 13 and 14:

### (a) Preparation of Toner 6:

A dispersion of microparticulate resin A1B1(5) was prepared in the same manner as the dispersion of microparticulate resin A1B1 used in the preparation of the toner 1, except that an addition amount of the dispersion of microparticulate resin B1 in the second polymerization step was changed to 45 parts by mass (as a solid). The weight average molecular weight (Mw) and glass transition temperature (Tg) of the thus prepared particulate resin A1B1(5) were the same as those of the particulate resin dispersion A1B1. Toner 6 was prepared in the same manner as the toner 1, except that formation of core particles was performed by using a dispersion of microparticulate resin A1B1(5) in place of the dispersion of microparticulate resin A1B1.

### (b) Preparation of Toner 7:

A dispersion of microparticulate resin A1B1(15) was prepared in the same manner as the dispersion of microparticulate resin A1B1 used in the preparation of the toner 1, except that an addition amount of the dispersion of microparticulate resin B1 in the second polymerization step was changed to 151 parts by mass (as a solid). The weight average molecular weight (Mw) and glass transition temperature (Tg) of the thus prepared particulate resin A1B1(15) were the same as those of the dispersion of microparticulate resin A1B1. Toner 7 was prepared in the same manner as the toner 1, except that formation of core particles was performed by using the dispersion of microparticulate resin A1B1(15) in place of the dispersion of microparticulate resin A1B1.

### (c) Preparation of Toner 13:

A dispersion of microparticulate resin A1B1(2) was prepared in the same manner as the dispersion of microparticulate resin A1B1 used in the preparation of the toner 1, except that an addition amount of the dispersion of microparticulate resin B1 in the second polymerization step was changed to 17 parts by mass (as a solid). The weight average molecular weight (Mw) and glass transition temperature (Tg) of the thus prepared particulate resin A1B1(2) were the same as those of the particulate resin dispersion A1B1. Toner 13 was prepared in the same manner as the toner 1, except that formation of core particles was performed by using the dispersion of microparticulate resin A1B1(2) in place of the dispersion of microparticulate resin A1B1.

### (d) Preparation of Toner 14:

A dispersion of microparticulate resin A1B1(20) was prepared in the same manner as the dispersion of microparticulate resin A1B1 used in the preparation of the toner 1, except that an addition amount of the dispersion of microparticulate resin B1 in the second polymerization step was changed to 213 parts by mass (as a solid). The weight average molecular weight (Mw) and glass transition temperature (Tg) of the thus prepared particulate resin A1B1(20) were the same as those of the particulate resin A1B1. Toner 14 was prepared in the same manner as the toner 1, except that formation of core particles was conducted by using the dispersion of microparticulate resin A1B1(20) in place of the dispersion of microparticulate resin A1B1.

### (4) Preparation of Toners 8 and 9:

### (a) Preparation of Toner 8:

The microparticulate resin. B4 was prepared in the same manner as the microparticulate resin B1, except that, in preparation of the dispersion of microparticulate resin A1B1 used in the preparation of the toner 1, addition amounts of the compounds used for preparation of the dispersion of microparticulate resin B1 was varied as below:

| | |
|---|---|
| n-Butyl acrylate | 288 parts |
| Methyl methacrylate | 852 parts |
| Itaconic acid | 60 parts |
| n-Octylmercaptan | 2.2 parts |

The weight average molecular weight (Mw) and glass transition temperature (Tg) of the thus prepared microparticulate resin B4 were 100,000 and 60° C., respectively. Further, a dispersion of microparticulate resin A1B4 was prepared in the same manner as the dispersion of microparticulate resin A1B1, except that a dispersion of microparticulate resin B4 was used; and toner 8 was prepared via the same process as in the toner 1.

### (b) Preparation of Toner 9:

The microparticulate resin B5 was prepared in the same manner as the microparticulate resin B1, except that, in preparation of the dispersion of microparticulate resin A1B1 used in the preparation of the toner 1, the addition amounts of the compounds used for preparation of the dispersion of microparticulate resin B1 was varied as below, and the addition amount of an initiator, potassium persulfate (KPS) was varied to 7.5 parts by mass:

| | |
|---|---|
| n-Butyl acrylate | 126 parts |
| Methyl methacrylate | 1014 parts |
| Itaconic acid | 60 parts |

The weight average molecular weight (Mw) and glass transition temperature (Tg) of the thus prepared microparticulate resin. B5 were 400,000 and 85° C., respectively. Further, a dispersion of microparticulate resin A1B5 was prepared in the same manner as the dispersion of microparticulate resin A1B1, except that a dispersion of microparticulate resin B5 was used; and toner 9 was prepared via the same process as in the toner 1.

### (5) Preparation of Toners 10-12:

### (a) Preparation of Toner 10:

A dispersion of microparticulate resin B6 was prepared similarly to preparation of the toner 1, provided that in preparation of the dispersion of microparticulate resin A1B1, 945 parts of methyl methacrylate used in preparation of the resin microparticle dispersion B1 was replaced by 945 parts of ethyl methacrylate. The thus prepared resin particles B6 exhibited the same weight average molecular weight (Mw) and glass transition temperature (Tg) as the resin particles B1. Further, a dispersion of microparticulate resin A1B6 was prepared in the same manner as the dispersion of microparticulate resin A1B1, except that a dispersion of microparticulate resin B6 was used; and toner 10 was prepared via the same process as in the toner 1.

### (b) Preparation of Toner 11:

A dispersion of microparticulate resin B6 was prepared similarly to preparation of the toner 1, provided that in preparation of the dispersion of microparticulate resin A1B1, 60 parts of itaconic acid used in preparation of the dispersion of microparticulate resin B1 was replaced by 60 parts of maleic acid. The thus prepared resin particles 137 exhibited the same weight average molecular weight (Mw) and glass transition temperature (Tg) as the resin particles B1. Further, a dispersion of microparticulate resin A1B7 was prepared in the same manner as the dispersion of microparticulate resin A1B1, except that a dispersion of microparticulate resin B7 was used; and toner 11 was prepared via the same process as in the toner 1.

### (c) Preparation of Toner 12:

A dispersion of microparticulate resin B6 was prepared similarly to preparation of the toner 1, provided that in preparation of the dispersion of microparticulate resin A1B1, 945 parts of methyl methacrylate used in preparation of the resin microparticle dispersion B1 was replaced by 945 parts of ethyl methacrylate. The thus prepared resin particles 138 exhibited the same weight average molecular weight (Mw) and glass transition temperature (Tg) as the resin particles B1. Further, a dispersion of microparticulate resin A1B8 was prepared in the same manner as the dispersion of microparticulate resin A1B1, except that a dispersion of microparticulate resin B7 was used; and toner 12 was prepared via the same process as in the toner 1.

### (6) Preparation of Toner 15:

A resin A having a structure (non-enclosure) in which a resin B was not enclosed was prepared in accordance with the procedure below. In the process of preparing a dispersion of microparticulate resin A1B1 in the course of preparing the toner 1, the afore-mentioned second polymerization step and third polymerization step were undergone to fouri a dispersion of resin particles A1. The thus prepared resin particles A1 exhibited a weight average molecular weight (Mw) of 20,000 and a glass transition temperature (Tg) of 40° C.

Core particles were formed similarly to the afore-mentioned formation of core particles, provided that 430 parts by mass (solid) of the dispersion of microparticulate resin A1B1 was replaced by the following composition:

| | | |
|---|---|---|
| Particulate resin dispersion A1 | 418 | parts (solid) |
| Particulate resin dispersion B1 | 12 | parts (solid). |

Further, the process after shell formation was conducted similarly to preparation of the toner 1 to prepare a toner 15.

### (7) Preparation of Toner 18:

A dispersion of microparticulate resin 11 was prepared similarly to preparation of the dispersion of microparticulate resin B1 in the preparation of toner 1, provided that amounts of n-butyl acrylate and methyl methacrylate were changed to 208 parts by mass and 995 parts by mass, respectively, without using itaconic acid; and a dispersion of microparticulate resin A1B11 was prepared in the same manner as in preparation of the dispersion of microparticulate resin A1B1, except for using the dispersion of microparticulate resin 11. The weight average molecular weight (Mw) and the glass transition temperature (Tg) of microparticulate resin 11 were the same as those of the microparticulate resin B1. Toner 18 was prepared via a process similar to the preparation of the toner 1.

Physical properties of resins A and B constituting the thus prepared toners 1-18 are shown in Table 1.

TABLE 1

| | | | | | | Resin B | | | | | | |
|---|---|---|---|---|---|---|---|---|---|---|---|---|
| | | | | | | | | | Content of | | | |
| | Resin Particle | | Resin A | | | | Methacrylic | | monomer | | | |
| Toner | Dispersion | | Resin | | Tg | Dispersion | Ester | Polycarboxylic | units | | | *1(mass |
| No. | No. | Structure | No. | Mw | (° C.) | No. | Monomer | Vinyl Monomer | (mass %)*² | Mw | Tg (° C.) | %) |
| 1 | A1B1 | encl*³ | A1 | 20,000 | 40 | B1 | MMAC*⁴ | ITA*⁵ | 83.5 | 300,000 | 70 | 7.5 |
| 2 | A1B2 | encl | A1 | 20,000 | 40 | B2 | MMAC | ITA | 95.0 | 300,000 | 70 | 7.5 |
| 3 | A1B3 | encl | A1 | 20,000 | 40 | B3 | MMAC | ITA | 70.0 | 300,000 | 70 | 7.5 |
| 4 | A2B1 | encl | A2 | 10,000 | 30 | B1 | MMAC | ITA | 83.5 | 300,000 | 70 | 7.5 |
| 5 | A3B1 | encl | A3 | 30,000 | 50 | B1 | MMAC | ITA | 83.5 | 300,000 | 70 | 7.5 |
| 6 | A1B1(5) | encl | A1 | 20,000 | 40 | B1 | MMAC | ITA | 83.5 | 300,000 | 70 | 5.0 |
| 7 | A1B1(15) | encl | A1 | 20,000 | 40 | B1 | MMAC | ITA | 83.5 | 300,000 | 70 | 15.0 |
| 8 | A1B4 | encl | A1 | 20,000 | 40 | B4 | MMAC | ITA | 83.5 | 100,000 | 60 | 7.5 |
| 9 | A1B5 | encl | A1 | 20,000 | 40 | B5 | MMAC | ITA | 83.5 | 400,000 | 85 | 7.5 |
| 10 | A1B6 | encl | A1 | 20,000 | 40 | B6 | EMAC*⁶ | ITA | 83.5 | 300,000 | 70 | 7.5 |
| 11 | A1B7 | encl | A1 | 20,000 | 40 | B7 | MMAC | MAA*⁷ | 83.5 | 300,000 | 70 | 7.5 |
| 12 | A1B8 | encl | A1 | 20,000 | 40 | B8 | EMAC | MAA | 83.5 | 300,000 | 70 | 7.5 |
| 13 | A1B1(2) | encl | A1 | 20,000 | 40 | B1 | MMAC | ITA | 83.5 | 300,000 | 70 | 2.0 |
| 14 | A1B1(20) | encl | A1 | 20,000 | 40 | B1 | MMAC | ITA | 83.5 | 300,000 | 70 | 20.0 |
| 15 | A1 + B1 | non-encl*⁸ | A1 + B1 | 20,000 | 40 | B1 | MMAC | ITA | 83.5 | 300,000 | 70 | 7.5 |
| 16 | A1B9 | encl | A1 | 20,000 | 40 | B9 | MMAC | ITA | 65.0 | 300,000 | 70 | 7.5 |
| 17 | A1B10 | encl | A1 | 20,000 | 40 | B10 | MMAC | ITA | 99.0 | 300,000 | 70 | 7.5 |
| 18 | A1B11 | encl | A1 | 20,000 | 40 | B11 | MMAC | — | 83.5 | 300,000 | 70 | 7.5 |

*1Resin B/(Resin A + Resin B),
*²Content (mass %) of monomer units of methacrylic ester and polycarboxylic vinyl of resin B
*³Enclosure,
*⁴Methyl methacrylate,
*⁵Itaconic acid,
*⁶Ethyl methacrylate,
*⁷Maleic acid,
*⁸Non-enclosure

### 2. Preparation of Developers 1-18:

The thus prepared toners 1-18 were each mixed with a silicone resin-covered ferrite carrier having a volume average particle size of 50 μm to prepare developers 1-18 having a toner content of 6%.

### 3. Evaluation:

Using the thus prepared developers 1-18, the toners 1-18 were respectively evaluated with respect to glossiness of a toner image, and difference in glossiness within the same mint and between prints when perforating continuous printing. There was conducted evaluation with respect to low temperature fixability, crease fixing strength and thermal storage stability. Experiments using toner 1-15 (or developers 1-15) were denoted as Examples 1-15, respectively, and those using toners 16-18 (or developers 16-18) were also denoted as Comparison 1-3, respectively.

Each of the developers 1-8 was placed in a commercially available hybrid printer bizhub PRO C550 (made by Konica Minolta Business Technologies Inc.) corresponding to a two-component developing type image forming apparatus, as shown in FIG. 1 to perform evaluation. The evaluation by using the image forming apparatus was conducted under a temperature of 20° C. and a relative humidity of 55% RH, that is, an environment of ordinary temperature and humidity.

### Glossiness:

A solid image was printed on the first sheet of continuously printed sheets to determine glossiness of the fixed images. Glossiness of a fixed image was measured at a measurement angle of 75° using glossimeter GMX-203 (produced by Murakami Sbikisai-Gijutsu Kenkyusho) according to JIS Z 8741. Glossiness was a five-point mean value of values measured at five points of the central portion and the four corners of a measured image. When forming an image for evaluation of glossiness, the fixing temperature was set to 160° C. A sheet to make a fixed image employed commercially available glossy paper, POD Super Gloss 170 (produced by Oji Seishi Co., Ltd.; weight: 128 g/m², thickness: 0.17 mm). Evaluation was made based on the following criteria:

Grade A: glossiness of not less than 70%,

Grade B: glossiness of not less tan 60% and less than 70%,

Grade C: glossiness of less than 60%.

Of the above, grades A and B were acceptable in practice.
Glossiness difference within a printed sheet:

After performing continuous printing of 1,000 sheets of A4 size, a solid image was printed on an A3-size sheet and the glossiness of the central portion and the edge portion were measured and the difference in glossiness within an identical print was determined. Measurement of glossiness was the same as in the foregoing evaluation of glossiness. Evaluation was made based on the following criteria:

Grade A: a glossiness difference between central portion and edge portions being not more than 1% (no problem in practice),

Grade B: the foregoing difference being more than 1% and less than 5% (at a level of being not visually observable and no problem in practice),

Grade C: the difference being not less than 5% (the difference being visually observable and unacceptable in practice).

### Glossiness Difference Between Printed Sheets

Continuous printing of 1,000 sheets of A4 size was performed, solid images were formed on the 1st and 1000th sheets, the glossiness of the images were measured to determine the difference thereof. Measurement of glossiness was the same as in the foregoing evaluation of glossiness.

### Evaluation was Made Based on the Following Criteria:

Grade A: a glossiness difference between 1st and 1000th sheets being not more than 1% (no problem in practice),

Grade B: the foregoing difference being more than 1% and less than 5% (at a level of being not visually observable and no problem in practice),

Grade C: the difference being not less than 5% (the difference being visually observable and unacceptable in practice).

### Low Temperature Fixability:

Before performing the foregoing continuous printing, the surface temperature of the heating roller of the image forming apparatus was varied at intervals 5° C. in the range of 90 to 130° C. and evaluation was made with respect to occurrence of image staining due to fixing offset at the respective temperatures. Specifically, at the respective surface temperatures, an A4-sized image, carrying a 5 mm wide solid belt-formed image and a 20 mm wide halftone image which was arranged vertically to the conveyance direction was longitudinally conveyed to be fixed and a temperature range causing no image staining (non-offset region) was detected and evaluated based on the following criteria:

Grade A: a lower temperature limit of non-offset region being not more than 110° C. and non-off set region being not less than 15° C.,

Grade B: a lower temperature limit of non-offset region being not more than 120° C. and non-off set region being less than 15° C.,

Grade C: a lower temperature limit of non-offset region being not less than 125° C.

### Crease Fixing Strength:

Crease fixing strength was evaluated by measurement of fixing factor of toner on a crease, that is, crease fixing factor. When internally folding the printed image surface, the crease fixing factor represents the extent of a toner being flaked off at the folded portion. Namely, after folding a solid image portion (having an image density of 0.8) internally and rubbing there with a finger three times, the image portion is opened and wiped three times with a JK wiper (made by Crecia Co., Ltd.) and from image densities at the folded portion before and after being folded, the crease fixing factor is calculated in accordance with the following equation:

Crease fixing factor (%)=[(image density after being folded)/(image density before being folded)]×100

The crease fixing strength was evaluated from the obtained crease fixing factor, based on the following criteria, in which grades A and B are acceptable in practice:

Grade A: the crease fixing factor being from 90 to 100% and the crease fixing strength being excellent,

Grade B: the crease fixing factor being not less than 80% and less than 90%, and th crease fixing strength being superior,

Grade C: the crease fixing factor being less than 80% and the crease fixing strength being insufficient.

### Thermal Storage Stability:

Thermal storage stability of the prepared toners was evaluated in the following manner. Namely, 100 g of each of the toners was allowed to stand for 4 hours under the conditions of 55° C. and 90% RH and sieved with a sieve with an opening of 45 μm and the thermal storage stability was evaluated in terms of the residual amount of aggregated materials on the sieve, based on the following criteria:

Grade A: the residual amount on the sieve being less than 5%, the amount of aggregated materials being very small and thermal storage stability being excellent (at a level of causing no aggregation even when being transported in summer without any heat-insulation packaging material),

Grade B: the residual amount on the sieve being not less than 5% and less than 20%, the amount of aggregated materials being small and thermal storage stability being superior (at a level of causing no aggregation even when transported in summer only in a corrugated board package,

Grade C: the residual amount on the sieve being not less than 20%, the amount of aggregated materials being large and unacceptable in practice (at a level of being necessary to perform cold transport)

The evaluation results are shown in Table 2.

TABLE 2

| | | | Glossiness | | | | | |
|---|---|---|---|---|---|---|---|---|
| | | | Difference in | | | | | |
| | | | Continuous- | | | | | |
| | | | printing | | | | | |
| | | | Within a | Between | Low Temperature | | Crease | Thermal |
| | | | Printed | Printed | Fixability | | Fixing | Storage |
| Example | Toner | Glossiness | Sheet | Sheets | Temperature*¹ | Region*² | Strength | Stability |
| No. | No. | (%) | (%) | (%) | (° C.) | (° C.) | (%) | (%) |
| 1 | 1 | 82 | 0 | 1 | 105 | 30 | 93 | 0 |
| 2 | 2 | 80 | 1 | 2 | 105 | 35 | 94 | 2 |
| 3 | 3 | 82 | 1 | 1 | 110 | 25 | 88 | 1 |
| 4 | 4 | 80 | 1 | 1 | 105 | 25 | 92 | 1 |
| 5 | 5 | 81 | 1 | 1 | 110 | 35 | 86 | 0 |
| 6 | 6 | 83 | 4 | 1 | 105 | 15 | 94 | 2 |
| 7 | 7 | 79 | 3 | 3 | 110 | 30 | 92 | 0 |
| 8 | 8 | 82 | 4 | 1 | 105 | 20 | 91 | 1 |
| 9 | 9 | 79 | 1 | 1 | 115 | 30 | 84 | 0 |
| 10 | 10 | 77 | 1 | 1 | 110 | 20 | 91 | 3 |
| 11 | 11 | 76 | 1 | 1 | 110 | 20 | 92 | 2 |
| 12 | 12 | 75 | 1 | 1 | 110 | 20 | 93 | 3 |
| 13 | 13 | 82 | 4 | 1 | 105 | 15 | 87 | 2 |
| 14 | 14 | 79 | 2 | 4 | 115 | 30 | 93 | 2 |
| 15 | 15 | 80 | 1 | 2 | 110 | 20 | 93 | 3 |
| Comp. 1 | 16 | 68 | 8 | 11 | 115 | 10 | 95 | 1 |
| Comp. 2 | 17 | 63 | 10 | 12 | 120 | 10 | 82 | 1 |
| Comp. 3 | 18 | 52 | 12 | 17 | 135 | 10 | 83 | 4 |

*¹A lower temperature limit of non-offset region (° C.)
*²Non-offset region (° C.)

As is apparent from Table 2, it was proved that Examples 1-15 employing toners satisfying the constitution of the present invention achieved enhanced glossiness and exhibited no scattering in glossiness within the same print or between prints, even when conducting continuous printing of 1,000 sheets, resulting in excellent gloss performance. There were also achieved excellent results in low temperature fixability, crease fixing strength and thermal storage stability. On the contrary, It was also confirmed that Comparison 1-3 resulted in unsatisfactory gloss performance, exhibiting clear difference in gloss performance from the toners satisfying the constitution of the invention.

What is claimed is:

1. A toner for electrostatic latent image development comprising a binder resin and a colorant, wherein the binder resin comprises a resin A comprising a copolymer comprised of at least a styrenic monomer unit and a (meth)acrylic monomer unit and a resin B comprising a copolymer comprised of at least a methacrylate monomer unit and a radical-polymerizable monomer unit containing plural carboxyl groups, and a total amount of the methacrylate monomer unit and the radical-polymerizable monomer unit containing plural carboxyl groups accounts for not less than 70% by mass and not more than 95% by mass of all monomer units forming the copolymer of the resin B.

2. The toner of claim 1, wherein the resin B accounts for not less than 2% by mass and not more than 20% by mass of a total amount of the resin A and the resin B.

3. The toner of claim 1, wherein the toner comprises toner particles each having a core/shell structure, and a core portion of the core/shell structure comprises the resin A and the resin B and a shell portion comprises the resin. A.

4. The toner of claim 1, wherein the resin A comprises a copolymer comprised of a styrenic monomer unit and a methacrylic monomer unit, in which the styrenic monomer unit and the methacrylic monomer unit account for 80 to 98% and 2 to 20% by mass of the resin A, respectively.

5. The toner of claim 1, wherein the resin A comprises a copolymer comprised of a styrenic monomer unit, a methacrylic monomer unit and an acrylic monomer unit, in which the styrenic monomer unit, the methacrylic monomer unit and the acrylic monomer unit account for 45 to 80%, 2 to 10% and 20 to 45% by mass of the resin A, respectively.

6. The toner of claim 1, wherein the resin A exhibits a glass transition temperature of not less than 30° C. and not more than 50° C., and a weight average molecular weight of not less than 10,000 and not more than 30,000.

7. The toner of claim 1, wherein the resin B comprises a copolymer comprised of at least a methacrylic acid ester monomer unit and a radical-polymerizable monomer unit containing plural carboxyl groups, and the methacrylic acid ester monomer unit is a monomer unit derived from methyl methacrylate or ethyl methacrylate and the radical-polymerizable monomer unit is a monomer unit derived from itaconic acid, maleic acid or fumaric acid.

8. The toner of claim 1, wherein the resin B exhibits a glass transition temperature of not less than 60° C. and not more than 85° C., and a weight average molecular weight of not less than 100,000 and not more than 400,000.

9. A method of producing a toner for electrostatic latent image development comprising a binder resin and a colorant, the method comprising:
allowing resin particles comprising a resin A and a resin B to aggregate,
wherein the resin A comprises a copolymer comprised of at least a styrenic monomer unit and a (meth)acrylic monomer unit and the resin B comprises a copolymer comprised of at least a methacrylic acid ester monomer unit and a radical-polymerizable monomer unit containing plural carboxyl groups to aggregate, and
a total amount of the methacrylic acid ester monomer unit and the radical-polymerizable monomer unit containing plural carboxyl groups accounts for not less than 70% by mass and not more than 95% of all monomer units to form the copolymer of the resin B.

10. The method of claim 9, wherein the method further comprises:
polymerizing at least a styrenic monomer and a (meth)acrylic monomer to form the resin A, and
polymerizing at least a methacrylic acid ester monomer and a radical-polymerizable monomer containing plural carboxyl groups to form the resin B.

11. The method of claim 9, wherein the resin B accounts for not less than 2% by mass and not more than 20% by mass of a total amount of the resin A and the resin B.

12. The method of claim 9, wherein the toner comprises toner particles each having a core/shell structure, and a core portion of the core/shell structure comprises the resin A and the resin B and a shell portion comprises the resin A.

13. The method of claim 9, wherein the resin A exhibits a glass transition temperature of not less than 30° C. and not more than 50° C., and a weight average molecular weight of not less than 10,000 and not more than 30,000.

14. A method of producing a toner for electrostatic latent image development comprising a binder resin and a colorant, the method comprising:
allowing particles comprising a resin A and particles comprising a resin B to aggregate,
wherein the resin A comprises a copolymer comprised of at least a styrenic monomer unit and a (meth)acrylic monomer unit and the resin B comprises a copolymer comprised of at least a methacrylic acid ester monomer unit and a radical-polymerizable monomer unit containing plural carboxyl groups to aggregate, and a total amount of the methacrylic acid ester monomer unit and the radical-polymerizable monomer unit containing plural carboxyl groups accounts for not less than 70% by mass and not more than 95% of all monomer units to form the copolymer of the resin B.

15. The method of claim 14, wherein the method further comprises:
polymerizing at least a styrenic monomer and a (meth)acrylic monomer to form the particles comprising a resin A, and
polymerizing at least a methacrylic acid ester monomer and a radical-polymerizable monomer containing plural carboxyl groups to form the particles comprising a resin B.

16. The method of claim 14, wherein the resin B accounts for not less than 2% by mass and not more than 20% by mass of a total amount of the resin A and the resin B.

17. The method of claim 14, wherein the toner comprises toner particles each having a core/shell structure, and a core portion of the core/shell structure comprises the resin A and the resin B and a shell portion comprises the resin A.

18. The method of claim 14, wherein the resin A exhibits a glass transition temperature of not less than 30° C. and not more than 50° C., and a weight average molecular weight of not less than 10,000 and not more than 30,000.
